(19) United States
(12) Patent Application Publication
(10) Pub. No.: US 2023/0180657 A1
(43) Pub. Date: Jun. 15, 2023

(54) ELECTRIC STAND-ON MOWER WITH COUNTER ROTATING BLADES

(71) Applicant: BRIGGS & STRATTON, LLC, Wauwatosa, WI (US)

(72) Inventors: Jeffrey Zeiler, Pewaukee, WI (US); Scott Funke, New Berlin, WI (US); Warren Corrado, Wauwatosa, WI (US); Mark Noller, Milwaukee, WI (US); Nick Zeidler, Brookfield, WI (US); Joshua Kowalski, Wauwatosa, WI (US)

(73) Assignee: BRIGGS & STRATTON, LLC, Wauwatosa, WI (US)

(21) Appl. No.: 17/767,789

(22) PCT Filed: Oct. 15, 2020
(86) PCT No.: PCT/US2020/055747

§ 371 Date: Apr. 8, 2022

Related U.S. Application Data
(60) Provisional application No. 62/915,574, filed on Oct. 15, 2019.

(51) Int. Cl. A01D 34/66; A01D 69/02; A01D 34/78; A01D 34/74

(52) U.S. Cl. CPC A01D 34/66; A01D 69/02; A01D 34/78; A01D 34/74

(57) ABSTRACT

Outdoor power equipment including a frame, a battery, multiple wheels, a cutting deck, multiple chore motors, and multiple blades. The cutting deck is coupled to the frame and has a discharge opening. The electric chore motors are attached to the cutting deck and are selectively powered by the battery. Each of the blades is powered and rotated by one of the multiple electric chore motors. A first blade of the multiple blades is rotated in a first direction and a second blade of the multiple blades is rotated in a second direction opposite the first direction.

### CROSS-REFERENCE TO RELATED APPLICATIONS

This application claims the benefit of U.S. Provisional Application No. 62/915,574, filed Oct. 15, 2019, which is incorporated herein by reference in its entirety.

### BACKGROUND

The present application relates generally to outdoor power equipment. More specifically, the present application relates to electric outdoor power equipment in the form of an electric mower, which may be battery powered.

### SUMMARY

One embodiment relates to outdoor power equipment including a frame, a battery, multiple wheels coupled to the frame, cutting deck, multiple electric chore motors, and multiple blades. The cutting deck is coupled to the frame and has a discharge opening. The electric chore motors are attached to the cutting deck and are selectively powered by the battery. Each of the blades is powered and rotated by one of the multiple electric chore motors. A first blade of the multiple blades is rotated in a first direction and a second blade of the multiple blades is rotated in a second direction opposite the first direction.

In some embodiments, the discharge opening is a rear discharge opening, wherein the cutting deck includes a top, a bottom, a right side, and a left side with respect to a forward direction of travel of the outdoor power equipment such that the top side is located closer to the frame than the bottom side, wherein the first blade of the plurality of blades is positioned on the right side of the cutting deck and the second blade of the plurality of blades is positioned on the left side of the cutting deck, and wherein the first blade of the plurality of blades is rotated in a counter-clockwise direction when viewed from the top of the cutting deck and the second blade of the plurality of blades is rotated in a clockwise direction when viewed from the top of the cutting deck.

In some embodiments, a third blade of the multiple blades is rotated in at least one of the first direction and the second direction, and the cutting deck further includes a first blade cavity housing the first blade, a second blade cavity housing the second blade, a third blade housing the third blade, a first baffle separating the first blade cavity and the third blade cavity, and a second baffle separating the second blade cavity from the third blade cavity.

In some embodiments, the cutting deck further includes a first sidewall located within the cutting deck, a second sidewall located within the cutting deck, a baffle forming a part of the first sidewall and the second sidewall, a first blade cavity housing the first blade and formed by the first sidewall and the baffle, and a second blade cavity housing the second blade and formed by the second sidewall and the baffle.

In some embodiments, the outdoor power equipment further includes a motor controller structured to control the operation of the multiple electric chore motors and positioned above the battery.

In some embodiments, the outdoor power equipment further includes a motor controller structured to control the operation of the multiple electric chore motors and positioned on the cutting deck.

In some embodiments, the outdoor power equipment further includes an operator platform and multiple drive motors selectively powered by the battery, wherein a first drive motor of the multiple drive motors is coupled to a first wheel of the multiple wheels and a second drive motor of the multiple drive motors is coupled to a second wheel of the multiple wheels, and wherein the operator platform is positioned underneath the first drive motor and the second drive motor in a normal operating position of the equipment.

Another embodiment relates to a cutting deck for use with an electric stand-on mower. The cutting deck includes a discharge opening, multiple electric chore motors attached to the cutting deck, and multiple blades. Each blade is powered and rotated by one of the multiple electric chore motors. A first blade of the multiple blades is rotated in a first direction and a second blade of the multiple blades is rotated in a second direction opposite the first direction.

In some embodiments, the discharge opening is a rear discharge opening, wherein the cutting deck includes a top, a bottom, a right side, and a left side with respect to a forward direction of operation of the cutting deck, wherein the first blade is positioned on the right side of the cutting deck and the second blade is positioned on the left side of the cutting deck, and wherein the first blade is rotated in a counter-clockwise direction when viewed from the top of the cutting deck and the second blade is rotated in a clockwise direction when viewed from the top of the cutting deck.

In some embodiments, the discharge opening is a side discharge opening, wherein the cutting deck includes a top, a bottom, a front, and a rear with respect to a forward direction of operation of the cutting deck, wherein the first blade is positioned on the front of the cutting deck and the second blade is positioned on the rear of the cutting deck, and wherein the first blade of is rotated in a counter-clockwise direction when viewed from the top of the cutting deck and the second blade is rotated in a clockwise direction when viewed from the top of the cutting deck.

In some embodiments, the cutting deck further includes a first sidewall located within the cutting deck, a second sidewall located within the cutting deck, a baffle forming a part of the first sidewall and the second sidewall, a first blade cavity housing the first blade and at least partially housing a first electric chore motor of the multiple electric chore motors, and a second blade cavity housing the second blade and at least partially housing a second electric chore motor of the multiple electric chore motors. The second blade cavity is formed by the second sidewall and the baffle. The first blade cavity is formed by the first sidewall and the baffle.

In some embodiments, the cutting deck further includes a first rear discharge opening and a second rear discharge opening separated by the baffle, wherein clippings from the first blade cavity are discharged through the first rear discharge opening and clippings from the second blade cavity are separately discharged through the second rear discharge opening.

In some embodiments, the cutting deck further includes a first axial scroll positioned around the first electric chore motor and a second axial scroll positioned around the second electric chore motor. The first axial scroll includes a first ramp structure tapering downward in the first direction and the second axial scroll includes a second ramp structure tapering downward in the second direction.

In some embodiments, a first distance from a center of the first electric chore motor to the first rear discharge opening is approximately equal in length to a second distance from a center of the second electric chore motor to the second rear discharge opening.

In some embodiments, the cutting deck further includes a first deflector plate positioned within the first rear discharge opening and a second deflector plate positioned within the second rear discharge opening. The first deflector plate including a first deflector plate opening through which clippings from the first blade cavity are discharged and the second deflector plate including a second deflector plate opening through which clippings from the second blade cavity are discharged.

Another embodiment relates to a lawnmower including a frame, a battery, multiple wheels coupled to the frame, a first electric chore motor coupled to a first blade and powered by the battery, a second electric chore motor coupled to a second blade and powered by the battery, and a cutting deck coupled to the frame. The cutting deck houses the first blade and the second blade and includes a first blade cavity and a second blade cavity. The first blade cavity and the second blade cavity are separated by a baffle. The first blade rotates in a first direction and the second blade rotates in a second direction. The first direction is opposite the second direction.

In some embodiments, the first direction is clockwise and the second direction is counter-clockwise and wherein clippings from the first blade and the second blade are discharged through a rear discharge opening in between a first wheel of the multiple wheels and a second wheel of the multiple wheels.

In some embodiments, the first direction is clockwise and the second direction is counter-clockwise and wherein clippings from the first blade and the second blade are discharged through a side discharge opening in between a first wheel of the multiple wheels and a second wheel of the multiple wheels.

In some embodiments, the lawnmower further includes an operator platform and wherein a first wheel of the multiple wheels and a second wheel of the multiple wheels have an outer diameter at least partially defining a rearmost surface of the first wheel and the second wheel of the plurality of wheels. The rearmost surface positioned rearward on the equipment than an entirety of the operator platform in a normal operating position of the equipment.

In some embodiments, the lawnmower further includes a third electric chore motor coupled to a third blade, wherein the cutting deck further houses the second blade, and wherein the third blade rotates in at least one of the first direction and the second direction.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description when taken in conjunction with the accompanying figures.

FIG. 1 is a front perspective view of outdoor power equipment in the form of an electric stand-on mower, according to an exemplary embodiment.

FIG. 2 is perspective view of a portion of the electric stand-on mower of FIG. 1, according to an exemplary embodiment.

FIG. 3 is a side view of the electric stand-on mower of FIG. 1, according to an exemplary embodiment.

FIG. 4 is a perspective view of a portion of the electric stand-on mower of FIG. 1, according to an exemplary embodiment.

FIG. 5 is a perspective view of the electric stand-on mower of FIG. 1, according to an exemplary embodiment.

FIG. 6 is a perspective view of a portion of the electric stand-on mower of FIG. 1, according to an exemplary embodiment.

FIG. 7 is a perspective view of a portion of the electric stand-on mower of FIG. 1, according to an exemplary embodiment.

FIG. 8A is a rear view of the electric stand-on mower of FIG. 1, according to an exemplary embodiment.

FIG. 8B is a side view of the electric stand-on mower of FIG. 1, according to an exemplary embodiment.

FIG. 8C is a perspective view of a portion of the electric stand-on mower of FIG. 1, according to an exemplary embodiment.

FIG. 8D is a top schematic view of the electric stand-on mower of FIG. 1, according to an exemplary embodiment.

FIG. 8E is a side schematic view of the electric stand-on mower of FIG. 1, according to an exemplary embodiment.

FIG. 9 is a rear perspective view of a portion of the electric stand-on mower of FIG. 1, according to an exemplary embodiment.

FIG. 10 is a top view of a user interface portion of the electric stand-on mower of FIG. 1, according to an exemplary embodiment.

FIG. 11 is a perspective view of a portion of the electric stand-on mower of FIG. 1, according to an exemplary embodiment.

FIG. 12 is a perspective view of a cutting deck of the electric stand-on mower of FIG. 1, according to an exemplary embodiment.

FIG. 13 is a top perspective view of a cutting deck for use with the electric stand-on mower of FIG. 1, according to an exemplary embodiment.

FIG. 14 is a bottom perspective view of the cutting deck of FIG. 13, according to an exemplary embodiment.

FIG. 15 is a bottom perspective view of the cutting deck of FIG. 13, according to an exemplary embodiment.

FIG. 16 is a bottom perspective view of the cutting deck of FIG. 13, according to an exemplary embodiment.

FIG. 17 is a bottom view of the cutting deck of FIG. 13, according to an exemplary embodiment.

FIG. 18 is a bottom perspective view of a cutting deck for use with the electric stand-on mower of FIG. 1, according to an exemplary embodiment.

FIG. 19 is a bottom view of a cutting deck for use with the electric stand-on mower of FIG. 1, according to an exemplary embodiment.

FIG. 20 is a bottom diagram view of a cutting deck for use with the electric stand-on mower of FIG. 1, according to an exemplary embodiment.

FIG. 21 is a bottom diagram view of a cutting deck for use with the electric stand-on mower of FIG. 1, according to an exemplary embodiment.

FIG. 22 is a bottom diagram view of a cutting deck for use with the electric stand-on mower of FIG. 1, according to an exemplary embodiment.

FIG. 23 is a bottom diagram view of a cutting deck for use with the electric stand-on mower of FIG. 1, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Although the description and figures herein describe the structure and operation of a stand-on electric mower, it should be understood that the components describe herein could be utilized with other types of outdoor power equipment such as riding tractors, snow throwers, pressure washers, tillers, log splitters, zero-turn radius mowers, walk-behind mowers, riding mowers, pavement surface preparation devices, industrial vehicles such as forklifts, utility vehicles, commercial turf equipment such as blowers, vacuums, debris loaders, overseeders, power rakes, aerators, sod cutters, brush mowers, sprayers, spreaders, etc.

Referring to the figures generally, an electric mower is illustrated. The electric mower includes one or more chore motors that are positioned substantially below the deck of the mower (e.g., “sub-flush” relative to the top surface of the deck). The motors are powered by an electrical energy source, such as a battery or generator, and controlled by a motor controller. The motor controller may be positioned remote from the motors (e.g., motor controller is positioned forward of the operator position and upward on the mower proximate the operator position). In other embodiments, the motor controller is otherwise positioned (e.g., on the mower deck). The operation of the electric mower is controllable through a user interface on the dashboard of the mower. A control system of the mower receives user inputs and performance data and controls various aspects and components of the mower based on that input and data. In some embodiments, the mower includes two chore motors and two blades. The chore motors rotate the blades (and airflow) inward toward the center of the mower deck in an opposite direction relative to each other (e.g., one chore motor rotates a blade in a counter-clockwise direction and one motor rotates a blade in a clockwise direction). The mower deck includes a rear discharge structured to discharge clippings through the rear of the mower deck. As the two blades counter-rotate relative to each other, the clippings cut by each blade are discharged through separate rear discharge channels or openings (e.g., with a baffle separating the rear discharge openings). The counter-rotating blades direct clippings through the separate rear discharge openings, reducing or eliminating the re-entrainment of clippings in the mower deck. In this way, clippings do not cycle through the mower deck housing more than once and clippings are substantially not cut by more than one blade. In addition, the likelihood of bogging down (e.g., excessively loading) the motors due to clippings clogging the housing is reduced or eliminated. In comparison with conventional mowers, where clippings from one blade must travel through a second blade (or a third blade) to exit the mower deck (e.g., in a side discharge cutting deck, in a cutting deck without a baffle), the cutting deck described herein keeps the clippings from each blade in substantially separate cavities, thereby eliminating clippings cycling through the cutting deck more than once. This reduces the wear on the chore motors, reduces the amount of electrical power necessary to operate each chore motor, and the overall power required to operate the mower. As described further herein, in other embodiments, the mower may include three or more chore motors and blades. In the three motor cutting deck, a similar arrangement may be used, where the clippings from each blade are substantially separately discharged through three separate channels or rear discharge openings. Similarly, the systems described herein can also be used on a four or five-motor cutting deck, where a similar arrangement is used, where the clippings from each blade may be substantially separately discharged through four or five separate channels or rear discharge openings.

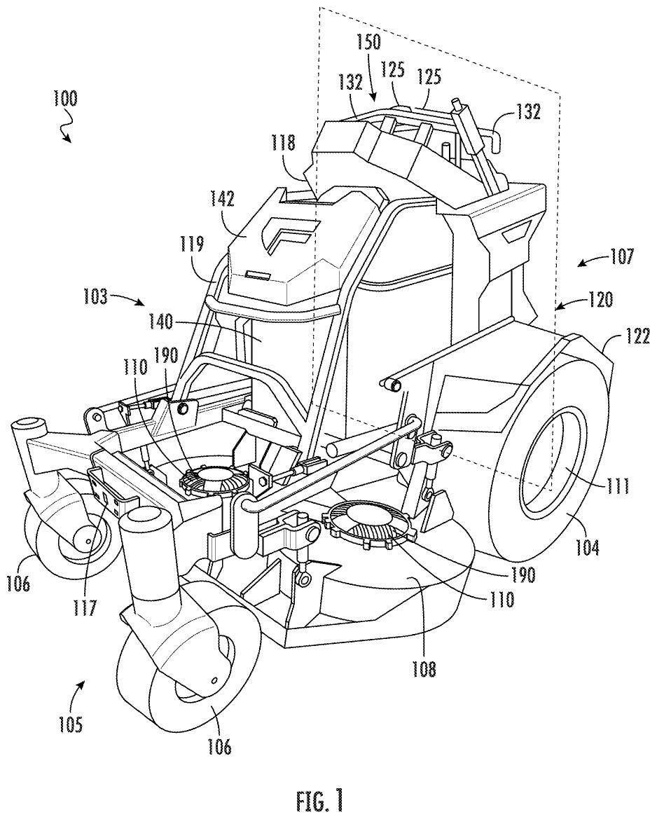

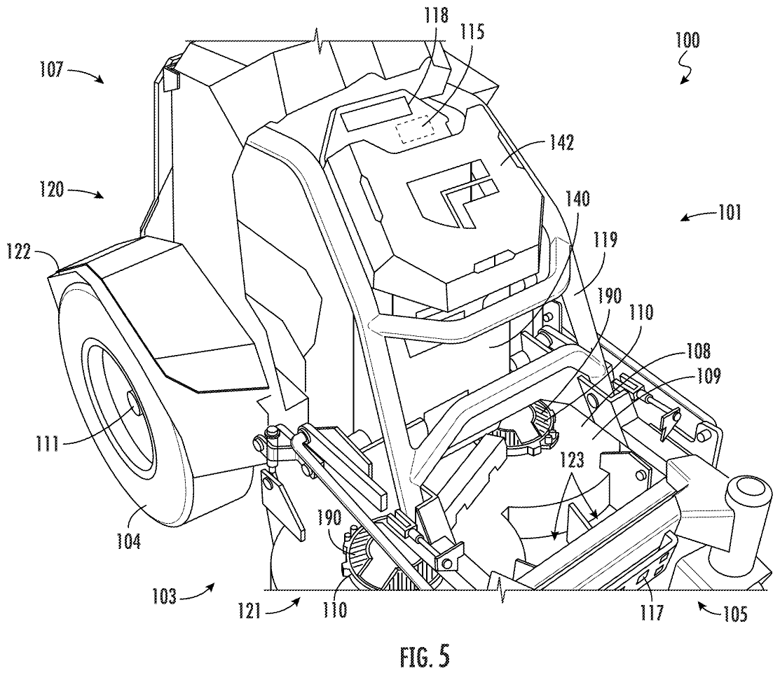

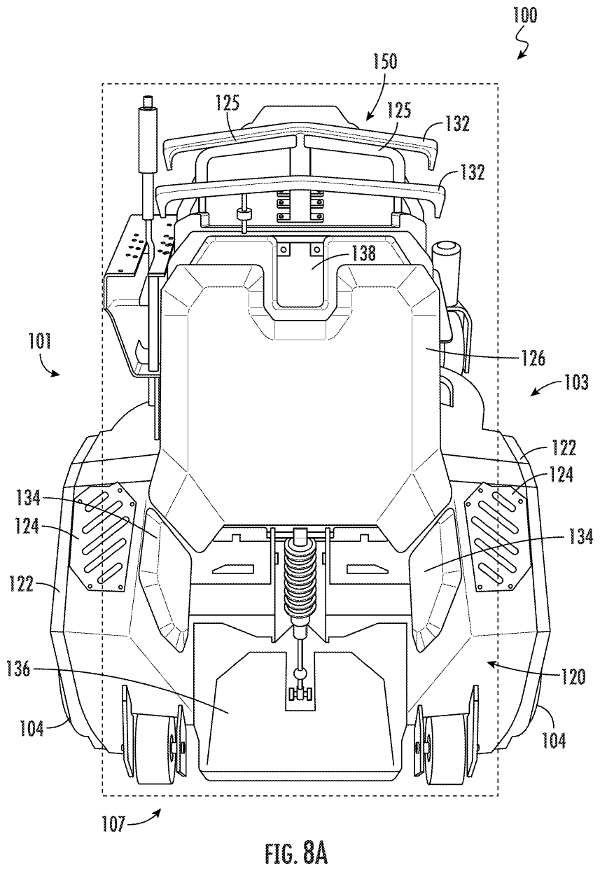

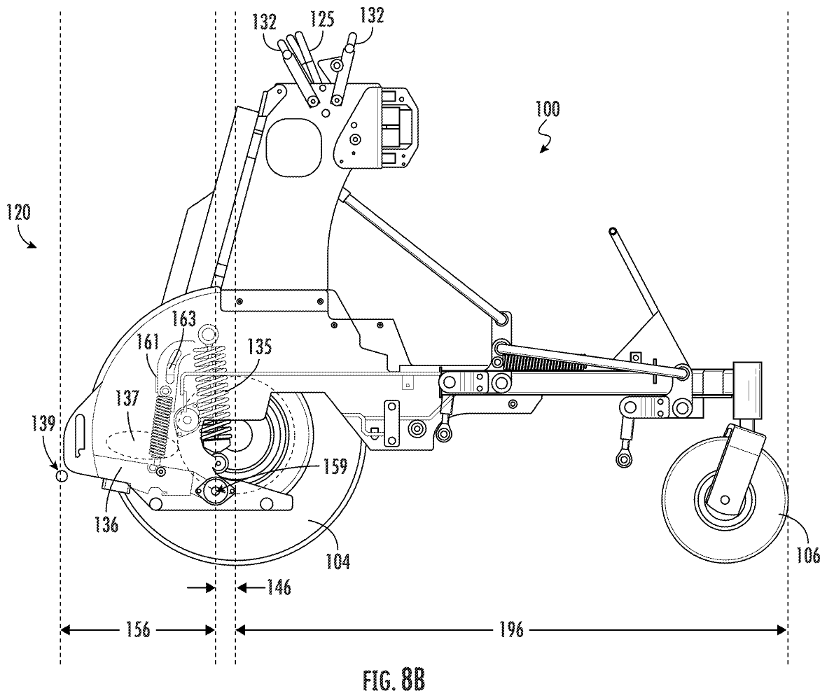

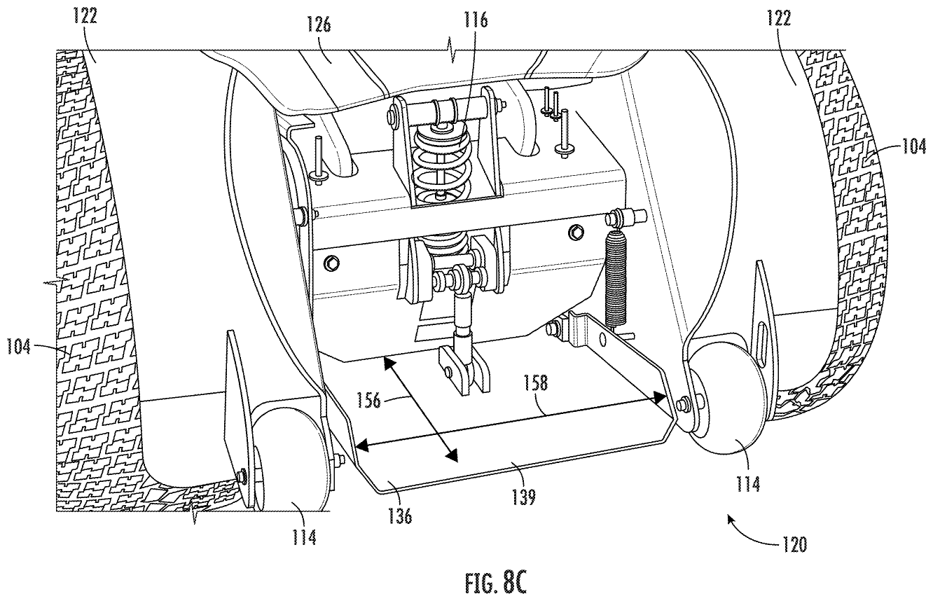

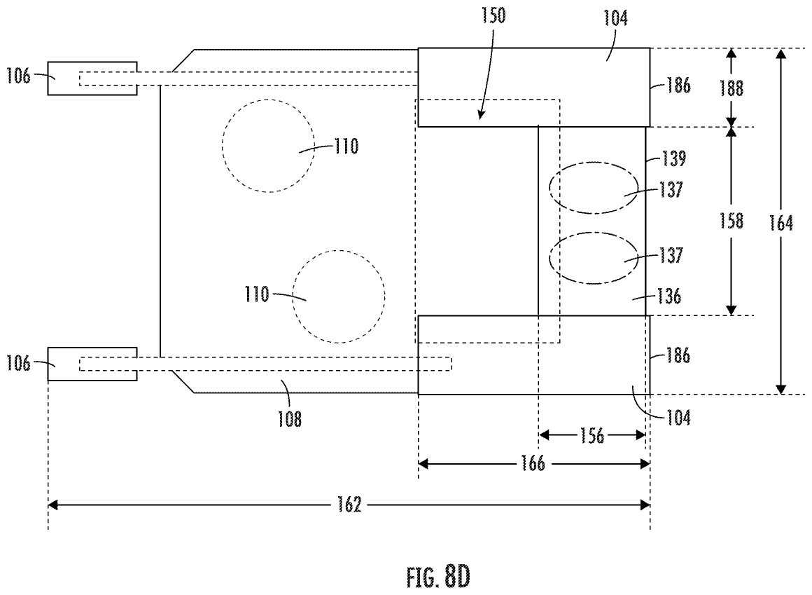

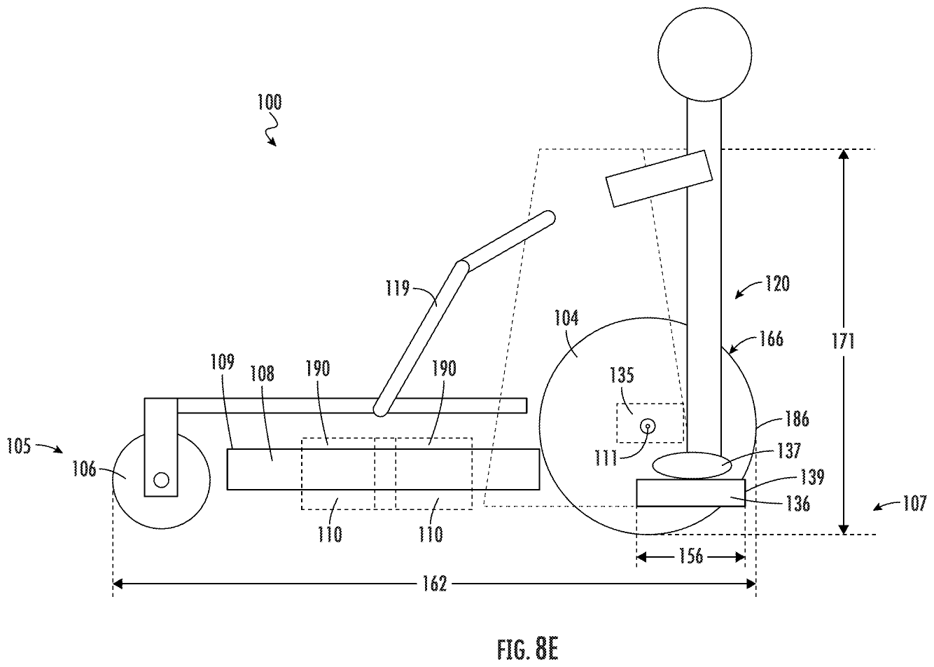

FIG. 1 illustrates a piece of outdoor power equipment, in the form of a stand-on electric mower 100, according to an exemplary embodiment. The mower 100 includes a left side 101, a right side 103, a front 105, and a rear 107. The mower 100 includes rear drive wheels 104 and front wheels 106. The rear drive wheels 104 are each powered by a drive motor (not shown). The top surface of each rear drive wheel 104 is covered along the top surface by a wheel cover 122. In other embodiments, the mower 100 can include more or less wheels and/or drive motors. In some embodiments, the front wheels 106 are powered by a drive motor. The mower 100 includes an energy storage device 140 (e.g., battery) positioned near the center of the mower 100. As shown in FIGS. 1 and 5, the energy storage device 140 is positioned under a shield 142 coupled to the tubular frame 119. As shown best in FIG. 8, an operator area 120 (shown by dashed area in FIGS. 1 and 8) is positioned proximate the rear 107 of the mower 100, where the operator faces toward the front 105 of the mower 100 while in operation.

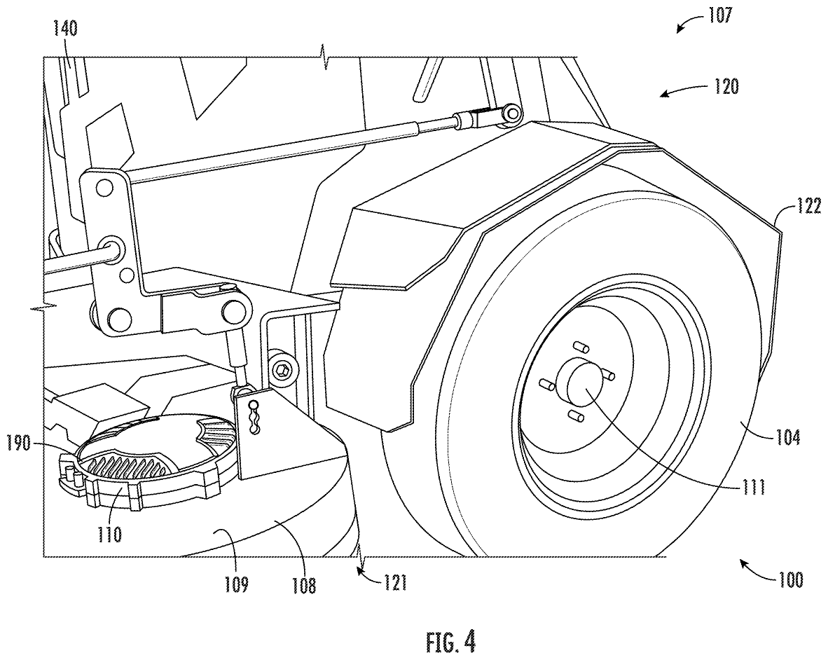

Referring to FIGS. 1-4, the mower 100 includes a cutting deck 108 positioned proximate the front 105 of the mower 100 and housing one or more chore motors 110 (e.g., shown as two chore motors 110 in FIG. 1). The cutting deck 108 is, at least in part, supported by a tubular frame 119. In other embodiments, the cutting deck 108 may be otherwise supported. The tubular frame 119 may protect the components of the mower 100 from being hit by objects such as branches and other debris. The tubular frame 119 also reduces the overall weight of the mower 100 as compared with a solid frame (e.g., solid steel frame). An accessory mount 117 is positioned proximate the front 105 of the mower 100 between the front wheels 106. A variety of accessories can be coupled to the accessory mount 117, such as lights, blowers, brush, other battery-powered tools, etc.

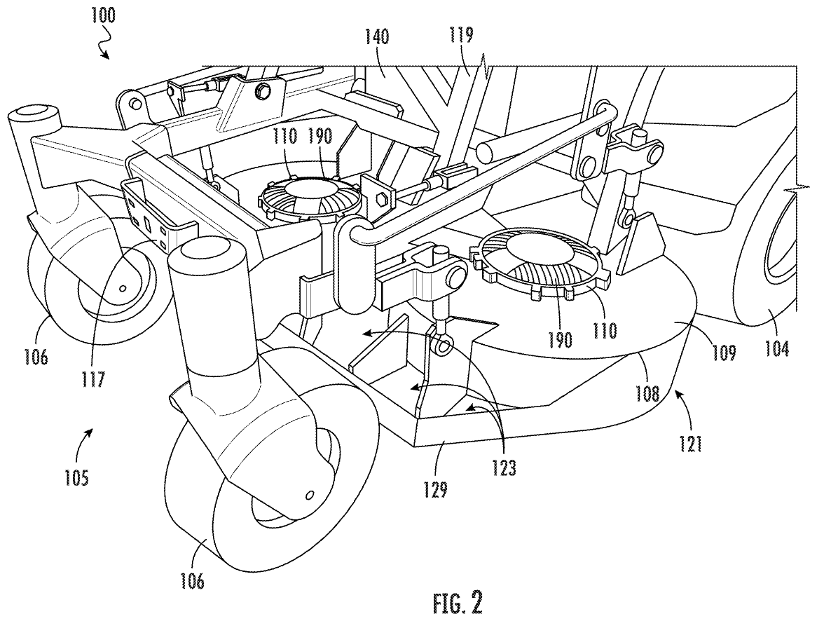

As shown in FIG. 2, the cutting deck 108 includes a housing portion 121 and a frame portion 129 extending from the housing portion 121 toward the front 105 of the mower 100. The frame portion 129 includes one or more openings 123 formed between the housing portion 121 of the cutting deck 108 and the front wheels 106. From the operator area 120, the operator can view the ground immediately in front of the cutting deck 108 (e.g., through the openings 123 formed in the mower deck 108 shown in FIG. 2). The positioning of the energy storage device 140 and motor controller 115 off of the cutting deck 108 (e.g., back and up toward the operator area 120, in the center of the mower 100 under shield 142), allows for the operator to view all areas immediately surrounding the mower and cutting deck 108. The motor controller 115 is positioned within a controller housing 118 (e.g., housing one or more other drive motor controllers and/or chore motor controllers), which is positioned at an angle as opposed to horizontally positioned such that the controller housing 118 can be fit underneath the shield 142 and conform within the overall package of the mower 100. In this way, the operator can view any obstructions (e.g., rocks, branches, roots) that may be immediately in front or to the side of the cutting deck 108 such that the operator can avoid the obstruction and/or stop the mower 100 and remove the obstruction. Accordingly, the likelihood of damage to the cutting blades or mower may be reduced. The angled mounting of the motor controller housing 118 also improves convective cooling of the motor controller 115. In addition, the reduction of material used for the cutting deck 108 reduces the overall weight of the mower 100 for better drive motor (and total mower) energy efficiency.

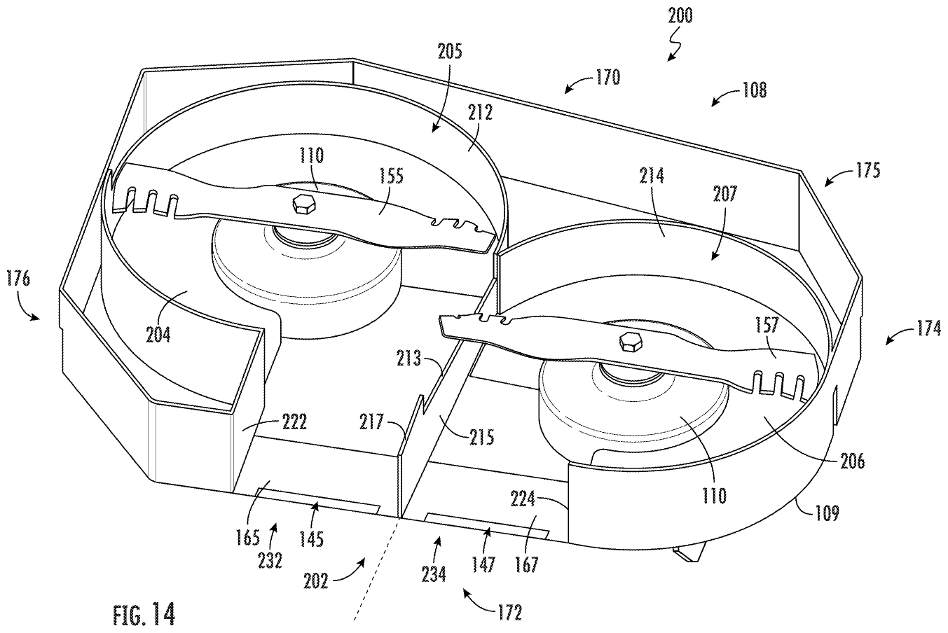

Referring to FIGS. 2-4, the chore motors 110 are electrically coupled to and powered by the energy storage device 140 and are controlled by a chore motor controller 115. The chore motors 110 are coupled to a rotary tool, such as a blade (e.g., cutting blades 155, 157 shown in FIG. 14) positioned beneath the cutting deck 108 of the mower 100. The chore motors 110 may be coupled to other tools, such as an auger, a saw, tines, blower, vacuum, brush, sprayer, a drill, a pump, etc. The cutting deck 108, chore motors 110, and blades are positioned proximate the front 105 of the mower 100 (e.g., substantially opposite from the operator area 120). In some embodiments, more or less chore motors 110 may be included.

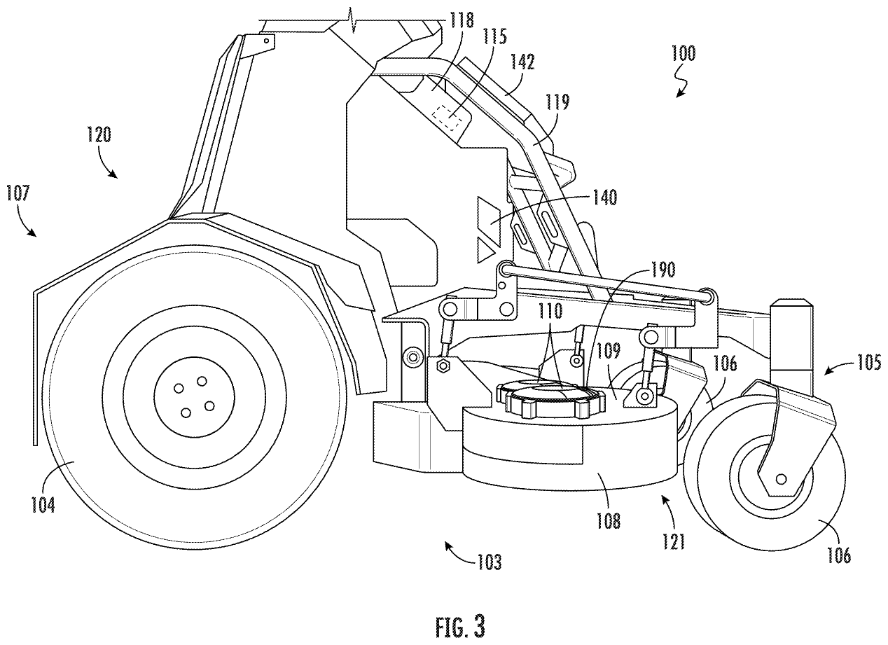

The chore motors 110 are sub-flush relative to the cutting deck 108. As used herein, the term “sub-flush” refers to a surface or a component being at least partially below a certain surface of another component. Accordingly, as shown in FIG. 3, the chore motors 110 (e.g., chore motor housings) are positioned at least partially below (or sub-flush relative to) the top surface 109 of the cutting deck 108. The chore motors 110 may be fastened (e.g., bolted) to the deck 108 using fasteners. The chore motors 110 extend below the deck 108, where the chore motors 110 are coupled to the cutting blades (e.g., cutting blades 155, 157 in FIG. 14).

In various embodiments, the chore motors 110 are positioned at least partially below the top surface 109 of the deck 108. In some embodiments, a substantial portion of the chore motor 110 is positioned below the top surface 109 of the cutting deck 108. In some embodiments, the motor 110 including the rotor and stator assemblies are positioned entirely below (e.g., sub-flush to) the cutting deck 108 (e.g., beneath the top surface 109 of the cutting deck 108), while the motor cover 190 is positioned at least partially above the deck 108 (as shown in FIG. 3). In some embodiments, all electronics included within chore motors 110 are positioned beneath the deck 108 (e.g., beneath the top surface 109 of the deck 108).

In conventional applications, all components of the chore motor 110 are positioned above the cutting deck, while the spindle is positioned below the deck. The positioning of the chore motors 110 relative to the cutting deck 108 as described herein allows for the deck 108 to be raised to a higher height for cutting higher grass (e.g., can be moved between a larger range of heights) without the chore motors 110 interfering with the mower frame. In addition, positioning the motor on top of the deck 108, as is conventionally done, allows very little air movement around the motor to convectively cool the motor. In this way, cooling air only comes from ambient air velocity and vehicle velocity. The limited cooling air is also partially blocked (or reduced) by the mower frame and deck mounting bracketry and can be completely blocked if or when the motor gets covered by grass and debris. By positioning the chore motor 110 at least partially under the deck 108, the forced air flow underneath the deck 108 caused by the blade rotation allows for better convective cooling of the chore motors 110.

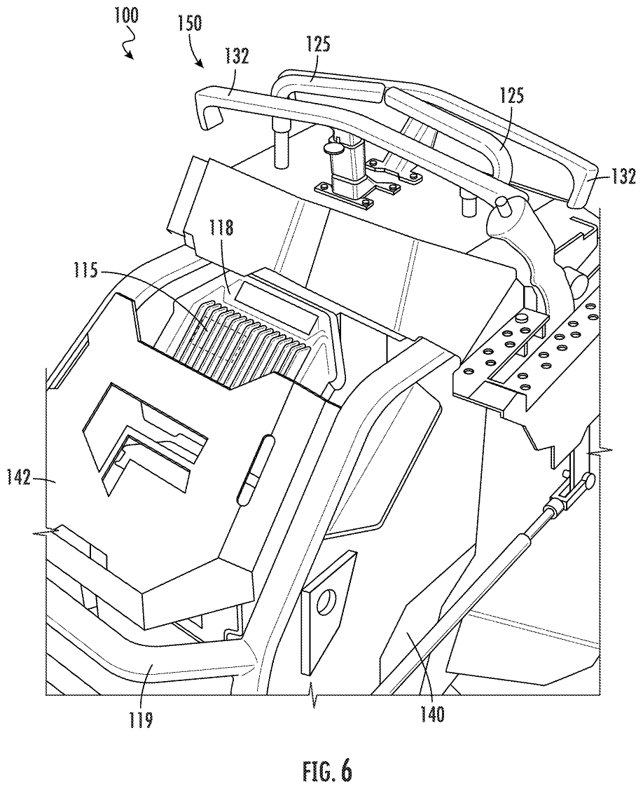

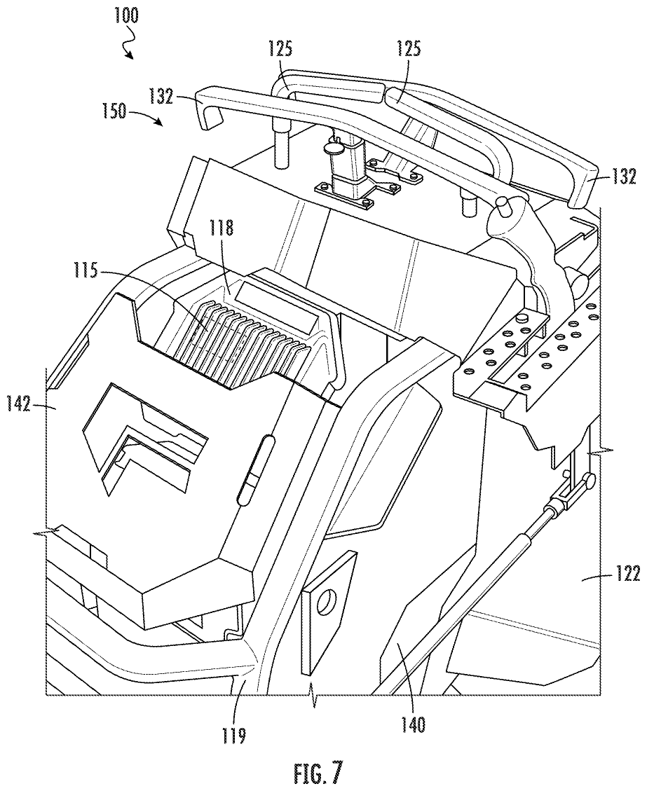

The operation of the chore motors 110 is controlled by the chore motor controller 115. Accordingly, the chore motors 110 are electrically, communicably, and operatively coupled to the chore motor controller 115. The chore motor controller 115 operates to control a chore motor 110 and can be mounted proximate the energy storage device 140 (e.g., under shield 142 as shown in FIGS. 6-7). In some embodiments, the motor controller 115 can be located on the deck 108 of the mower 100. In some embodiments, a motor controller 115 is integrated with (e.g., in a single housing with) each chore motor 110. The motor controller 115 can include manual or automatic means for starting and stopping the motors, selecting direction of rotation, selecting and controlling vehicle and blade speeds based on the size of the deck and blades, perform load-based control of mower speeds, protect the electronics, and various other features. In some embodiments, each chore motor 110 and drive motor have separate motor controllers. In some embodiments, one or more motor controllers 115 may be housed within a single controller module. The motor controllers 115 described herein include a communications port. The communications port can be configured to communicate with other motor controllers (e.g., via bus connections (e.g., a controller area network (CAN) bus)), can include analog inputs, analog outputs, digital inputs, digital outputs, a motor position connection, and/or other motor sensor inputs. Using a communications bus can reduce and/or minimize cabling. In some embodiments, the communications port includes two analog inputs, one analog output, digital input/output connections, CAN 2.0b connections, a motor position input, and other motor sensor inputs.

Referring to FIGS. 3 and 5, the energy storage device 140 is shown positioned beneath a shield 142 of the mower 100. The shield 142 allows air to flow through for ventilation and/or cooling purposes. The shield 142 also protects the energy storage device 140 and motor controller 115 (e.g., motor controller housing 118) from contact with branches or other objects that may hit the mower 100. The energy storage device 140 provides energy (e.g., electrical energy) to the components of the mower 100 including, but not limited to, the chore motors 110, drive motors, chore motor controller 115, traction motor controller, dashboard 150 (e.g., user interface), control system, accessories, etc. The energy storage device 140 can be liquid-cooled. The energy storage device 140 can be pre-heated for cold operation or during charging when cold using a heating element placed in the liquid flow path used for the liquid-cooled system. In some embodiments, energy storage device 140 includes a battery management system to control and monitor the operation thereof. The battery management system can ensure optimal operation of the mower 100 while protecting the energy storage device 140. The energy storage device 140 can be a battery or battery module and can include one or more distinct batteries including one or more battery cells (e.g., lithium ion battery cells and/or any other type of battery cell as described herein or that is suitable).

The energy storage device 140 can be a lithium-ion (Li-ion) battery, a lithium-ion Polymer (Li-pol) battery, a lead-acid battery, a nickel-cadmium (NiCd) battery, a nickel-metal hydride (NiMh) and/or any other type of battery configured to store and/or discharge energy. The energy storage device has a capacity of 10 kWh. In other embodiments, the energy storage device 140 may have various capacities, e.g., 0.1 kWh, 0.5 kWh, 1 kWh, 3 kWh, 5 kWh, 50 kWh, etc. Some or all of the energy storage devices/capacity may be removable. The energy storage device 140 may also be a capacitor, ultracapacitor, bank of capacitors, or an electrical generator (including a liquid or gaseous fuel storage device, engine, alternator, and rectifier), etc.

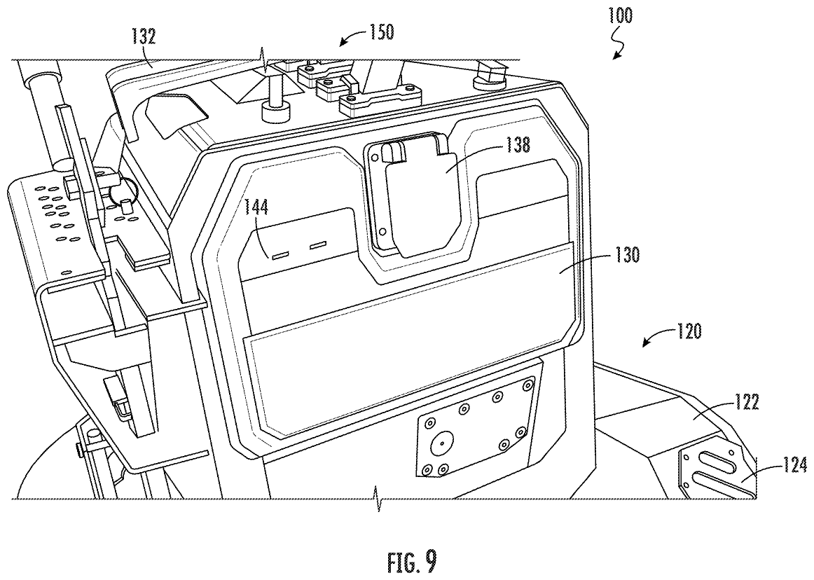

Referring to FIGS. 8A-10, the operator area 120 includes a platform 136 on which the operator stands while operating the mower 100. In some embodiments, the platform 136 is positioned within the outermost surface 186 (e.g., the outermost diameter) of the rear drive wheels 104 (e.g., within the overall package size of the mower 100). As such, the rearmost surface or edge 139 of the platform 136 is positioned closer to the rear drive axle 111 than the outermost surface 186 (e.g., the outermost diameter) of the rear drive wheels 104. Accordingly, the rearmost surface or edge 139 of the platform 136 is positioned nearer the front 105 of the mower 100 than the outermost surface 186 (e.g., outermost diameter) of the rear drive wheels 104. In this way, the platform 136 does not extend past the outer diameter or outermost surface 186 of the rear drive wheels 104. In some embodiments, a substantial portion of or a majority of the operator platform 136 is positioned in front of the outermost portion or surface 186 (e.g., outermost diameter) of the rear drive wheels 104. In this way, the operator is positioned substantially within the overall package size of the mower, feels more in control of the operation of the mower, and safer and more balanced while operating the mower. Conventional stand-on mowers typically include an operator platform which is located (or substantially located) outside the outermost portion (e.g., outermost diameter or surface) of the drive wheels. In some embodiments, the rearmost surface or edge 139 of the operator platform 136 (e.g., surface of the platform 136 closest to the rear 107 of the mower 100) is the rearmost point of the mower 100. As shown in FIG. 8C, the mower 100 also includes small wheels 114 coupled to mower 100 proximate the rearmost surface or edge 139 of the platform. The small wheels 114 limit or prevent the mower 100 from falling or tipping backward. In some embodiments, the small wheels 114 (or the outermost diameter of the small wheels 114) are the rearmost point of the mower 100.

Referring to FIG. 8B, the platform 136 includes a pivot point 159. The platform 136 pivots about the pivot point 159 and is coupled to and supported by spring 161 and damper 163. In this way, the platform 136 supports and cushions the weight of the operator (e.g., platform 136 is biased against the operator's weight by spring 161 and is dampened by damper 163) and rotates about the pivot point 159 to comfortably support the operator while the operator stands on the platform 136. This may reduce the fatigue on the operator. In some embodiments, the pivot point 159 may be positioned approximately 1.8 inches behind the center (e.g., rear axle 111) of the rear drive wheels 104. The platform 136 may include sensors to detect when the operator is positioned on the platform 136 (e.g., to operate chore motors 110, etc.). The platform 136 may include rubber material providing additional grip and shock absorption for the operator's feet.

Referring to FIGS. 8B-8C, a length 156 of the platform 136 (e.g., from the rearmost edge or surface 139 to the innermost edge or surface of the platform 136) is approximately 13.5 inches (e.g., 13.446 inches). In some embodiments, the length 156 of the platform 136 may be more or less than 13.5 inches. In some embodiments, the length 156 of the platform 136 may be within a range of 13 inches to 14 inches. A width 158 of the platform (e.g., defined from the left edge proximate the left drive wheel 104 to the right edge of the platform 136 proximate the right drive wheel 104) is approximately 14.25 inches. In some embodiments, the width 158 of the platform 136 may be more or less than 14.25 inches. In some embodiments, the width 158 of the platform 136 may be within a range of 14 inches to 14.5 inches.

Still referring to FIG. 8B, a length 196 from the outermost edge (e.g., outermost diameter) of the front wheels 106 to the center of the rear drive wheels 104 (e.g., rear drive wheel axle 111) is approximately 49.5 inches. In some embodiments, the length 196 may be more or less than 49.5 inches. In some embodiments, the length 196 may be within a range of 49 inches to 50 inches. A length 146 from the center of the rear drive wheels 104 (e.g., rear drive wheel axle 111) to the forward-most (or innermost) point of the platform 136 is approximately 1.8 inches. The length 146 may be more or less than 1.8 inches.

Referring still to FIGS. 8A-10, in some embodiments, a portion of the rear drive wheels 104 (e.g., rear axle 111) is positioned substantially underneath an operator while standing on the platform 136. In this way, the weight of the operator is centered generally over the rear axle 111. As shown in FIG. 8E, a portion (e.g., a substantial portion) of the operator's feet (shown as 137 in FIGS. 8B and 8E) is positioned underneath (e.g., substantially underneath) the drive motors (e.g., shown as 135 in FIG. 8E) in a normal operating position of the mower 100. The entirety of the operator's feet 137 are also positioned nearer the front 105 of the mower 100 than the outermost diameter 186 of the rear drive wheels 104. In this way, the operator's feet 137 are positioned within the overall package of the mower 100 nearer the center of the mower 100 than the outermost surface 186 (e.g., outer diameter) of the rear drive wheels 104. In some embodiments, a portion of the operator's feet are located underneath the motor controller 115 and energy storage device 140. In comparison with typical units where the operator's feet are positioned in line with the outermost portion (e.g., outermost surface or diameter) of the rear drive wheels, the operator's feet on the mower 100 described herein are positioned more inward and toward the center of weight of the mower 100. This positioning may add to the control and safety the operator feels while operating the mower 100.

Referring to FIGS. 8D and 8E, schematic views of the mower 100 are shown, according to an exemplary embodiment. The overall length 162 of the mower 100 (e.g., from outermost surface of front wheels 106 to outermost surface of rear drive wheels 104) may be approximately 63.8 inches. In some embodiments, the overall length 162 may be more or less than 63.8 inches. In some embodiments, the overall length 162 is approximately 65.4 inches (e.g., on a three-blade mower with a 48-inch deck).

The overall width 164 of the mower 100 is approximately 36.2 inches. The overall width 164 may be more or less than 36.2 inches. In some embodiments, the overall width 164 is approximately 48.8 inches (e.g., on a three-blade mower with a 48-inch deck). The overall height 171 (e.g., defined from the topmost surface of the user interface to the bottom surface of the rear drive wheels 104) of the mower 100 is approximately 47.5 inches. In some embodiments, the overall height 171 may be more or less than 47.5 inches. The overall height 171 may be the same on a three-blade mower with a 48-inch deck. A mower with larger decks may also be used with the systems described herein. For example, a mower with a 52-inch deck or a 61-inch deck may be used. A mower with a 52-inch deck may have an approximate overall length of 67 inches and approximate overall width of 54 inches. A mower with a 61-inch deck may have an approximate overall length of 72 inches and an approximate overall width of 64 inches.

The rear drive wheels 104 include an outer diameter 166 of approximately 23 inches. In some embodiments, the outer diameter 166 may be more or less than 23 inches. The rear drive wheels 104 include a width 188 of approximately 8.5 inches. In some embodiments, the rear drive wheels 104 include a width 188 of more or less than 8.5 inches. In some embodiments, the width 188 of the rear drive wheels 104 is approximately 10.5 inches (e.g., on a three-blade mower with a 48-inch deck).

Padding 126 is positioned on the backside of the mower 100 and underneath the drive levers 125 and may support or cushion the operator while the operator is standing on the platform 128 such that the operator may rest or lean a portion of his or her body on the padding 126. The padding 126 may be a single piece thigh pad, which increases operator stability by enabling a wider stance and providing support on the lower leg of the operator. The mower 100 also includes side padding 134 positioned on the inside of each wheel cover 122. The side padding 134 cushions the operator's legs when the mower 100 is being operated on the side of an incline or hill. The mower 100 also includes step plates 124 formed on or coupled to each wheel cover 122. An operator can place a foot on one of the step plates 124 for leverage when turning and/or mowing up, down, or on a side-hill incline. The step plates 124 can provide additional traction for the operator's foot during a side-hill mower operation. In some embodiments, the mower 100 includes an accessory container 130 accessible by the operator for placing items such as garbage, debris, etc. In some embodiments, the accessory container 130 is removably mounted onto a frame of the mower 100. The mower 100 also includes an easy-access charge port 138 and one or more USB charging ports 144 positioned near the padding 126.

The mower 100 includes drive levers 125 (e.g., right drive lever, left drive lever) movable by the operator to change the speed of the mower 100 in a forward and backward direction and to change direction of the mower 100 in forward, backward, right, and left directions. The mower 100 also includes one or more handles 132 designed to be grasped by an operator standing on the platform 128. The handles 132 surround the drive levers 125, extending forward and rearward of the drive levers 125 and act as reference points to which the drive levers 125 may be moved forward and backward, thereby mechanically limiting the top speeds in the forward and backward direction of the mower 100. The handles 132 may be adjusted forward or backward by the operator to limit the forward and backward movement of the drive levers 125. In this way, the handles 132 may be adjusted for varying levels of experience (e.g., novice, experienced operators) and/or for varying types of jobsites (e.g., flat terrain, steep hills, small lawns, large lawns, etc.). Alternatively, or in combination with the handle 132 positioning, mower speed can be controlled via the user interface and drive controller software.

The drive levers 125 are coupled to drive motors, which are coupled to (e.g., engage with) and control the rotation of the rear drive wheels 104. In some embodiments, the drive motors 127 are mounted onto the chassis of the mower 100 from the outside of the rear drive wheels 104. The drive wheels 104 rotate differently in response to various operator inputs at the drive levers 125. Accordingly, when the operator moves the drive levers 125 in a forward direction, the rear drive wheels 104 rotate in a forward direction to propel the mower 100 forward. When the operator moves the drive levers 125 in a backward direction, the rear drive wheels 104 rotate in the backward direction to drive the mower 100 backward. In addition, when the right or left drive levers 125 are moved forward or backward separately (e.g., right drive lever is moved separately from the left drive lever), the drive motors and drive wheels 104 respond accordingly. For example, when the right drive lever is moved forward and the left drive lever remains stationary, the right rear drive wheel 104 is rotated faster than the left drive wheel 104 and the mower 100 is caused to move to the left, and vice versa. The drive levers 125 may also act to engage and/or disengage the blades 155, 157 (FIG. 14). For example, if an operator returns the drive levers 125 to the neutral position, and lets go of one or more of the drive levers 125 the blades 155 may be disengaged. A power-take-off switch 148 is also included on the dashboard 150.

In some embodiments, a traction controller can receive one or more drive inputs to drive the mower 100 at a particular speed. The drive inputs may indicate an operator-defined drive speed for a first drive wheel and a second drive wheel. The traction controller and/or multiple other controllers and/or circuits, can operate the drive motors to drive the mower 100 based on the operator-defined drive speed. In addition, in some embodiments, the traction controller and/or the chore motor controller can determine one or more chore motor speeds for a chore motor 110, the chore motor speeds being proportional to the drive speed. In this regard, the speed of a chore device, e.g., the blades 155, 157, can be proportional to how fast the mower 100 (e.g., drive wheels 104) is moving. By adjusting the speed of the chore motor 110, electrical energy can be saved. If the mower 100 is stationary or moving slowly, it may be a waste of energy to operate the blade 155, 157 at a high speed. However, if the mower 100 is moving quickly, the blade 155, 157 may need to operate at the high speed to efficiently cut grass. In this regard, the speed of the chore motor 110 can be based on the drive speed for the mower 100. Alternatively, the chore motors 110 can also be operated independently of the drive motors such that the speed of the blades 155, 157 is controlled separately and independently of the drive speed of the mower 100. This may be beneficial to compensate for off-normal grass cutting conditions (e.g., dry, wet, tall, dense, thin, etc.) and/or to conserve energy.

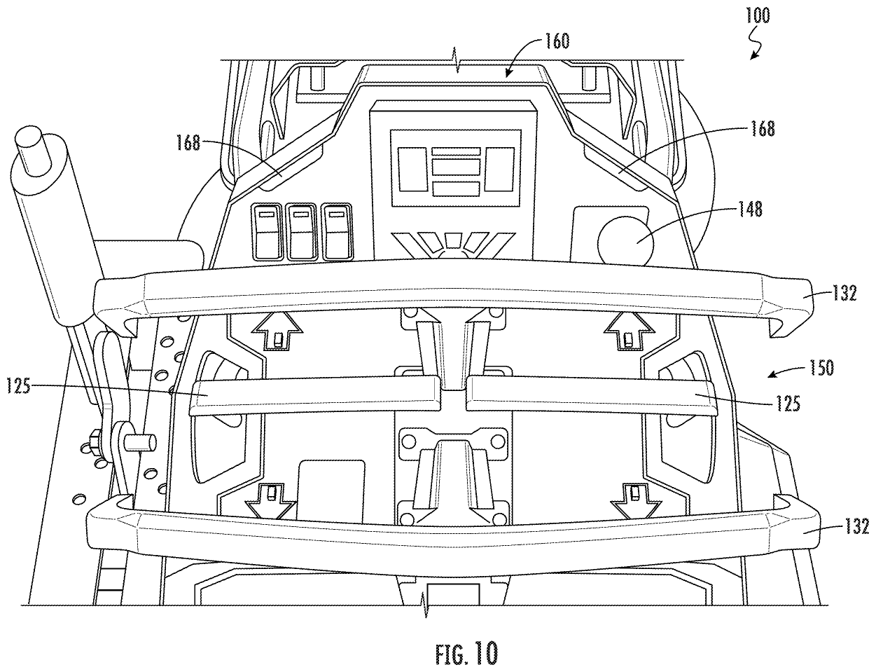

Referring to FIG. 10, the mower 100 includes a dashboard 150 operable by the operator to control certain operating or performance conditions of the mower 100. The dashboard 150 includes a user interface 160, which displays current operating conditions, maintenance notifications and/or warnings to the operator. The dashboard 150 and user interface 160 are positioned in view of the operator such that when the operator is standing on the platform 136, the operator can clearly see the dashboard 150 and user interface 160 in his or her line of sight. Accordingly, the dashboard 150 and user interface 160 are positioned near the center of the mower 100 proximate the drive levers 125 and handles 132.

The user interface 160 also includes a touchscreen and/or selector interfaces (e.g., push-buttons, toggles, etc.) which may receive input from the operator. The selector interfaces may correspond to similar functions on the touchscreen. In some embodiments, an operator interacts with one of the selector interfaces to activate the touchscreen. Through interaction with the user interface 160, the operator inputs commands into the control system (e.g., motor controller 115), which in turn, controls the mower 100 based on the operator input.

In some embodiments, the dashboard 150 can include an indicator 168 (e.g., one or more LEDs) placed proximate the user interface 160 which indicate, via color (e.g., red, yellow, green) a power draw for each of the batteries of the mower 100. In some embodiments, the indicator 168 indicates the operational efficiency with which the operator is operating the mower 100. In some embodiments, the indicator 168 includes lights under the shield 142 surrounding the energy storage device 140 and motor controller 115 as well. In some embodiments, if the systems described herein are used on outdoor power equipment which is a hybrid device, the equipment can indicate an amount of energy usage of each of the motors to the operator. Providing these power draw indications can indicate to an operator which parts of the equipment are using the power and in what amount. The dashboard 150 can include one or more light emitting diodes (LEDs), a display screen (e.g., a LED screen, a touch screen, a resistive touch screen, a capacitive touch screen, etc.), a steering wheel, a throttle control, one or more drive sticks, buttons (e.g., one or more buttons to enable a chore function (e.g., power take-off switch, turn on lawn mower blades, turn off lawn mower blades, select blade speed, start spreader, stop spreader, select spreader speed, turn on compressor, etc.), and/or any other input and/or output device.

In some embodiments, the user interface 160 is configurable by the operator. In this way, the operator can program in the specific job or a series of jobs (e.g., a day's worth of jobs) to be completed by the mower 100. Accordingly, the operator can input route information and other specific information for the jobsite (e.g., size, incline, etc.). In some embodiments, the display can illustrate the optimum or most efficient route for a particular jobsite. The optimum route may be programmed into the control system by previous operators and/or a system administrator. The optimum route can be displayed to the operator through the user interface 160 as a “ghost” route (e.g., using augmented reality), where the operator can follow along the route by viewing the suggested route through the user interface 160. The display can also provide an indication of the current time, runtime, blade operation time, remaining battery life time, etc., to the operator. The display can also provide an indication of whether the blades 155, 157 (FIG. 14) are currently operational (e.g., blades are off, blades are on). In some embodiments, the operator may be required to provide a passcode to enter into the display prior to operating the mower 100.

As an example, the indicator 168 displays a green light if the operational efficiency is higher than a predetermined efficiency. The indicator 168 may also display a yellow light if the operational efficiency is between a first predetermined efficiency and a second predetermined efficiency. The indicator 168 may also display a red light if the operational efficiency is below the second predetermined efficiency. The indicator 168 may transition between various colors depending on the determined operational efficiency of the mower 100. The operational efficiency may be determined by conditions such as overcharge of the energy storage device 140, overuse of the drive motors or drive wheels 104, and overuse of the chore motors 110 or blades 155, 157. Using the indicator 168, the operator may adjust the way he or she is operating the mower 100 (e.g., adjust vehicle or blade speed, cutting height, etc.) and as such, can extend the ride time. The operator may also receive operational data feedback in other ways, such as, but not limited to, through indications on smart glasses, smart watch, etc. Other status indicators can include malfunction warnings, where when lit, store a fault code related to any malfunction detected with the mower 100. In this case, a scan tool can be used for further diagnosis of the malfunction.

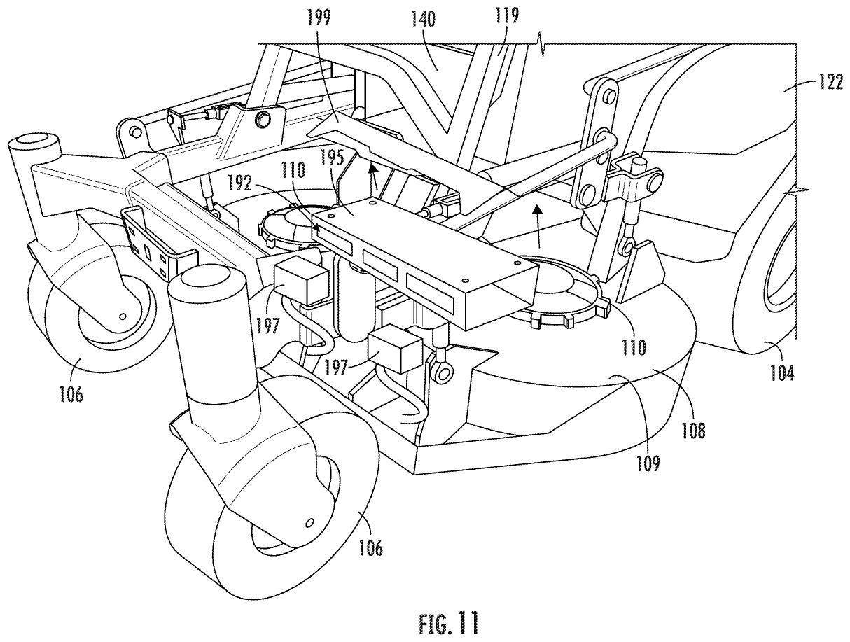

Referring now to FIG. 11, a front perspective view of a portion of the electric stand-on mower is shown, according to an exemplary embodiment. The mower 100 includes a distribution box 195 including one or more outlets 192 formed therein. The outlets 192 include female ports configured to be communicably and operatively coupled to one or more mating connectors 197. The outlets 192 each include a connection interface including two power ports (e.g., cylindrical in shape) and one data communication port positioned between the two cylindrical power ports. The connection interfaces (e.g., connectors) may be similar to that of U.S. Pat. No. 7,806,737, filed Feb. 4, 2008, which is incorporated herein by reference in its entirety. The mating connectors 197 communicably and electrically couple the outlet 192 to the one or more chore motors 110. The distribution box 195 is coupled to the underside of the portion of the frame 199 beneath and proximate the energy storage device 140. This positioning may allow short connection lines between the distribution box 195 and the energy storage device 140. The distribution box 195 may also be centered and proximate the cutting deck 108 in order to easily run connection lines (e.g., motor phase lines, communication lines, etc.) down to the chore motors 110 and any other implements. In some embodiments, the distribution box 195 has more or less outlets 192 than shown in FIG. 11 and has covers for any outlets without a connection to a motor or an implement.

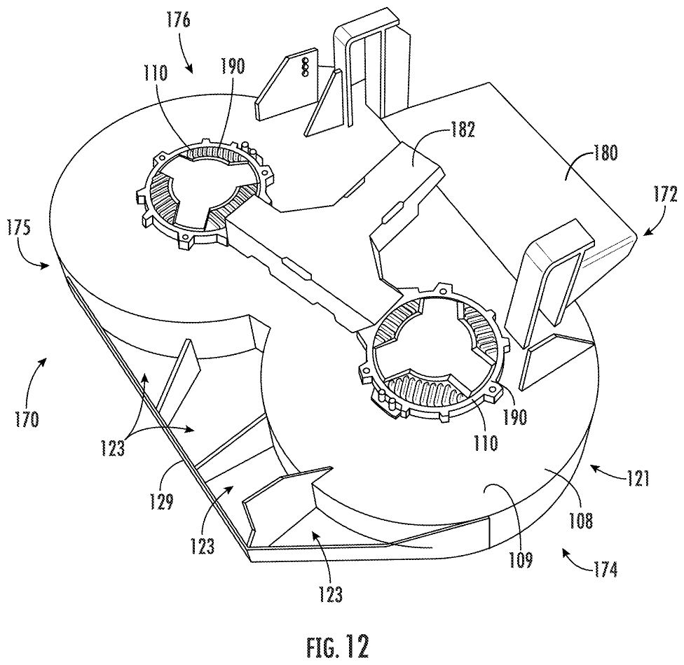

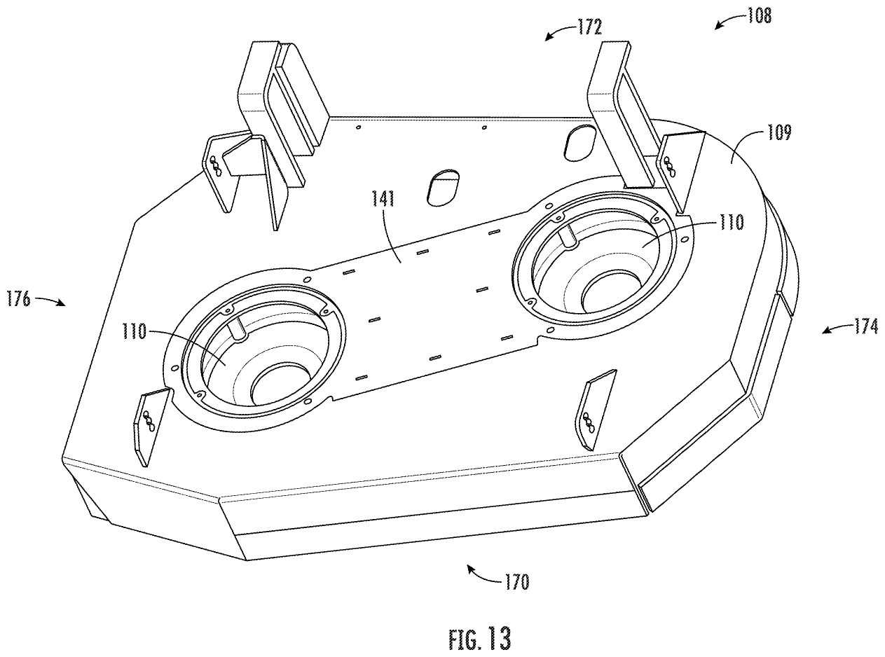

Referring to FIGS. 12-13, the cutting deck 108 is shown from a top perspective view, according to an exemplary embodiment. The cutting deck 108 includes a front 170, rear 172, left side 174, right side 176, and an underside 175. The cutting deck 108 includes one or more chore motors 110 positioned in and extending therethrough. The chore motors 110 rotate blades 155, 157 (FIG. 14) on the underside 175 of the cutting deck 108. The chore motors 110 and blades 155, 157 may be removable from the cutting deck 108 (e.g., for maintenance, replacement) through the apertures formed in the deck and covered by deck cover 141. The deck cover 141 can include one or more mechanisms (e.g., quick-release mechanisms, devices, handles, etc.) movable between a locked position and an unlocked position. To remove the cover 141, the operator lifts directly up (e.g., substantially perpendicular to top surface 109 of deck 108) while grasping the mechanisms. The motors 110 and blades 155, 157 can then be removed through the aperture in the cutting deck 108. The majority of each chore motor 110 is positioned below the top surface 109 of the cutting deck 108 (e.g., positioned on the underside 175 of the cutting deck 108). Each chore motor 110 includes a cover 190 coupling the chore motor 110 to the cutting deck 108. A wire routing cover 182 may be included to house any cables running from the chore motors 110 to another component on the mower 100. The wire routing cover 182 may be in a “T” or “Y” shape. The cutting deck 108 includes a rear discharge 180 positioned at the rear 172 of the cutting deck 108. The cutting deck 108 may be thermoformed as shown and described in U.S. Publication No. 2017/0245433, filed Feb. 10, 2017, which is incorporated herein by reference in its entirety. In some embodiments, the cutting deck 108 may be a fabricated deck made of plate steel, which is bent and welded. The cutting deck 108 may be a 36-inch mower deck. In some embodiments, the cutting deck 108 may be of a different size (e.g., 48-inch mower deck).

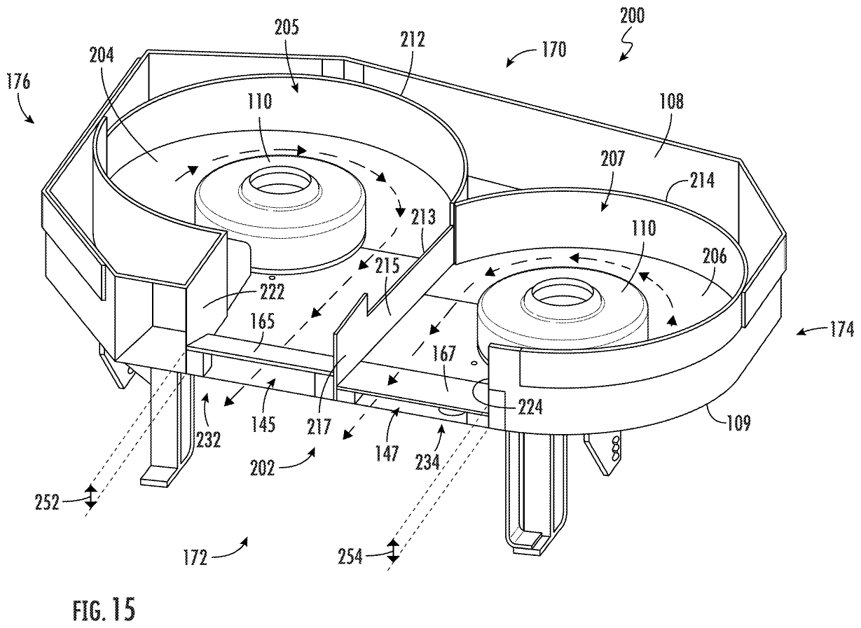

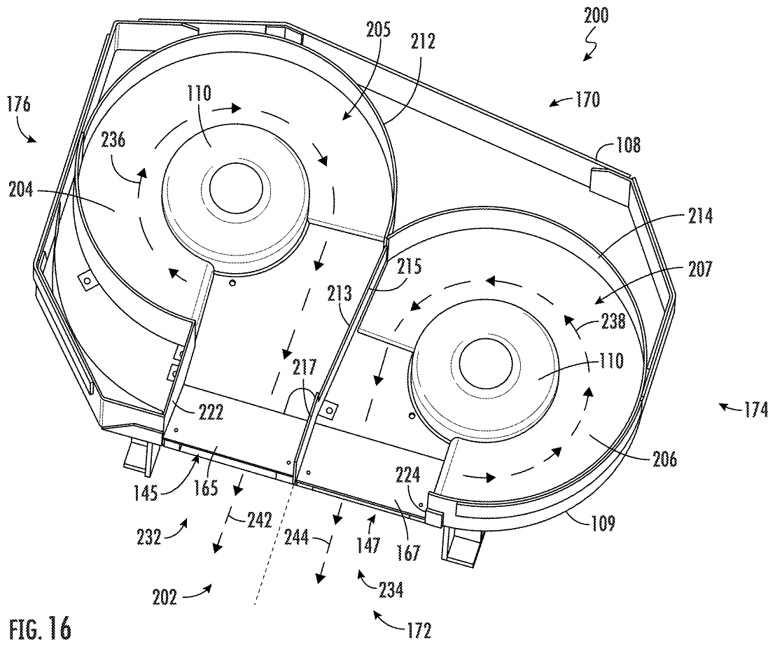

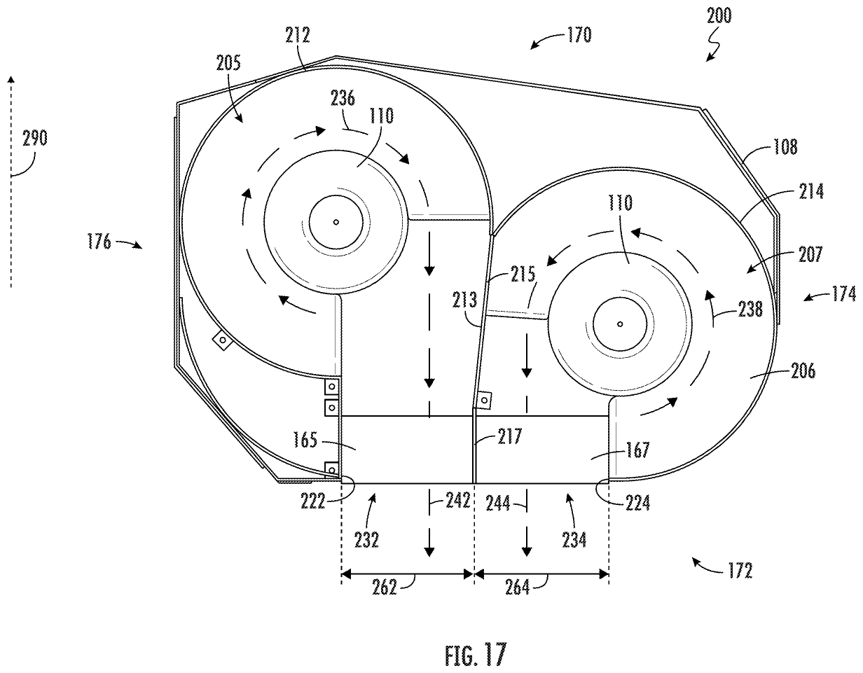

Referring to FIGS. 14-17, a cutting assembly 200 is shown, according to an exemplary embodiment. The view of the cutting assembly 200 is from the underside 175 of the cutting deck 108. The chore motors 110 are each coupled to and rotate respective blades 155, 157. The right blade 155 is coupled to the chore motor 110 on the right side 176 of the cutting deck 108 and the left blade 157 is coupled to the chore motor 110 on the left side 174 of the cutting deck 108. The right blade 155 rotates in a clockwise motion when viewing the deck 108 as shown in FIG. 14 (e.g., from the underside 175). The left blade 157 rotates in a counter-clockwise motion when viewing the deck 108 as shown in FIG. 14 (e.g., from the underside 175). As such, each of the right blade 155 and the left blade 157 rotates inward toward the center of the deck 108 such that the right blade 155 rotates in an opposite direction relative to the rotation of the left blade 157. Additionally, the cutting assembly 200 and the deck 108 are shown in relationship to a forward direction of travel 290 (i.e., forward direction of operation). The forward direction of travel 290 is the direction of travel when the mower 100 and therefore the cutting assembly 200 and the deck 108 are moving forward (opposite of reverse). The forward direction of operation is the direction of travel when the cutting assembly 200 is operated in the forward direction.

The cutting deck 108 includes a right housing 212 (e.g., a first sidewall in the form of a right sidewall that extends within and from a top of the cutting deck 108 towards the bottom of the cutting deck 308), a left housing 214 (e.g., a second sidewall in the form of a left sidewall that extends within and from a top of the cutting deck 108 towards the bottom of the cutting deck 108), and a rear discharge opening 202. The rear discharge opening 202 is defined between a right housing end wall 222 and a left housing end wall 224. The right housing 212 and left housing 214 are generally in a partial circular shape (e.g., the right sidewall and the left sidewall that form the right housing 212 and the left housing 214 are partially circular). The right housing 212 and the left housing 214 are shaped and sized to allow the blades 155, 157 to rotate therein (e.g., the right sidewall and the left sidewall create a hollow portion therein that is shaped and sized to allow the blades 155, 157 to rotate and fit therein), with a small clearance around the circumference of the housings 212, 214 between the blades 155, 157 and the inner surfaces of the housings 212, 214.

A baffle 215 forms a part of both the right housing 212 and the left housing 214 (e.g., a part of the right sidewall and the left sidewall). The baffle 215 extends within the cutting deck 108 from the rear discharge opening 202. The baffle 215 extends from the top of the cutting deck 108 at least partially into the underside 175 of the cutting deck 108. In some embodiments, the baffle 215 extends over half way into the underside 175 of the cutting deck 108. A right blade cavity 205 is formed by the right housing 212 and the baffle 215 and a left blade cavity 207 is formed by the left housing 214 and the baffle 215. The right blade 155 rotates within the right blade cavity 205 and the left blade 157 rotates within the left blade cavity 207. The baffle 215 separates the right blade cavity 205 from the left blade cavity 207. The baffle 215 includes a lower wall portion 213 and a higher wall portion 217. The lower wall portion 213 is positioned to allow the left blade 157 to pass over the lower wall portion 213. The baffle 215 may help to improve or increase the vacuum created by the rotation of blades 155, 157 within the right and left blade cavities 205, 207.

The rear discharge opening 202 includes a right rear discharge opening 232 and a left rear discharge opening 234. The right rear discharge opening 232 is defined between the right housing end wall 222 and the baffle 215. The left rear discharge opening 234 is defined between the left housing end wall 224 and the baffle 215. The right rear discharge opening 232 includes a width 262 of approximately half the width of the right blade 155. The left rear discharge opening 234 includes a width 264 of approximately half the width of the left blade 157. Clippings exit the right rear discharge opening 232 and the left rear discharge opening 234 in between the rear drive wheels 104. In some embodiments, the right rear discharge opening 232 includes a width 262 greater than half the width of the right blade 155 and the left rear discharge opening 234 includes a width 264 greater than half the width of the left blade 157. In some embodiments, clippings exit the right rear discharge opening 232 and the left rear discharge opening 234 both in between and into the rear drive wheels 104 (FIG. 1) for greater grass dispersion area.

The cutting deck 108 further includes a right deflector plate 165 and a left deflector plate 167. The right deflector plate 165 is positioned within the right rear discharge opening 232 and the left deflector plate 167 is positioned within the left rear discharge opening 234 (e.g., at the rear discharge opening 202 of the cutting deck 108). As air and clippings exit the cutting deck 108, the air and clippings pass over the right deflector plate 165 and left deflector plate 167 (e.g., at right opening 145 and left opening 147). The right and left deflector plates 165, 167 deflect clippings down toward the ground (e.g., when the mower 100 is in an operational position shown in FIG. 1). The right deflector plate 165 and left deflector plate 167 are angled relative to the underside surface of the cutting deck 108 at a right deflector plate angle 252 and a left deflector plate angle 254, respectively. In some embodiments, the smaller the angle of the right deflector plate angle 252 and the left deflector plate angle 254, the high efficiency experienced by the cutting assembly 200. The right deflector plate angle 252 and the left deflector plate angle 254 are equal. In some embodiments, the right deflector plate angle 252 and the left deflector plate angle 254 are not equal.

A right scroll insert 204 (e.g., axial scroll insert) may be positioned within the right blade cavity 205 and a left scroll insert 206 (e.g., axial scroll insert) may be positioned within the left blade cavity 207. The right scroll insert 204 and the left scroll insert 206 may be angled (e.g., in the shape of a ramp) and circular in shape such that the scroll inserts 204, 206 surround respective chore motors 110 and the center of blades 155, 157. The scroll inserts 204, 206 ramp downward from proximate respective end walls 222, 224 (e.g., from a height of approximately 1.5 inches) toward the baffle 215 in each blade cavity 205, 207 (e.g., ramp downward to a height of zero inches in a direction toward the direction of blade rotation). The scroll inserts 204, 206 may improve the air flow efficiency within the cutting deck 108. In some embodiments, the scroll insert 204, 206 are a metallic material. In some embodiments, the scroll inserts 204, 206 are non-metallic (e.g., a composite material).

As the right blade 155 rotates, clippings (and air) within the right blade cavity 205 are directed (e.g., pushed) toward the right rear discharge opening 232 as shown by clockwise arrow 236. As the left blade 157 rotates, clippings within the left blade cavity 207 are directed (e.g., pushed) toward the left rear discharge opening 234 as shown by counter-clockwise arrow 238. The clippings (and air) within right blade cavity 205 move in a clockwise direction (e.g., arrow 236) and then straight out of the right rear discharge opening 232 (e.g., shown by arrow 242). The clippings (and air) within the left blade cavity 207 move in a counter-clockwise direction (e.g., arrow 238) and then straight out of the left rear discharge opening 234. (e.g., shown by arrow 244).

In some embodiments, instead of a right blade cavity 205 and a left blade cavity 207, the cutting deck 108 includes a right pod and a left pod. The right pod houses the right blade 155 and the left pod houses the left blade 157. Each pod may include a separate discharge opening to discharge clippings cut by the respective blades in the respective pods. Each pod may include a deflector plate similar to the right and left deflector plates 165, 167 described herein and each pod may include a scroll insert similar to the right and left scroll inserts 204, 206 described herein.

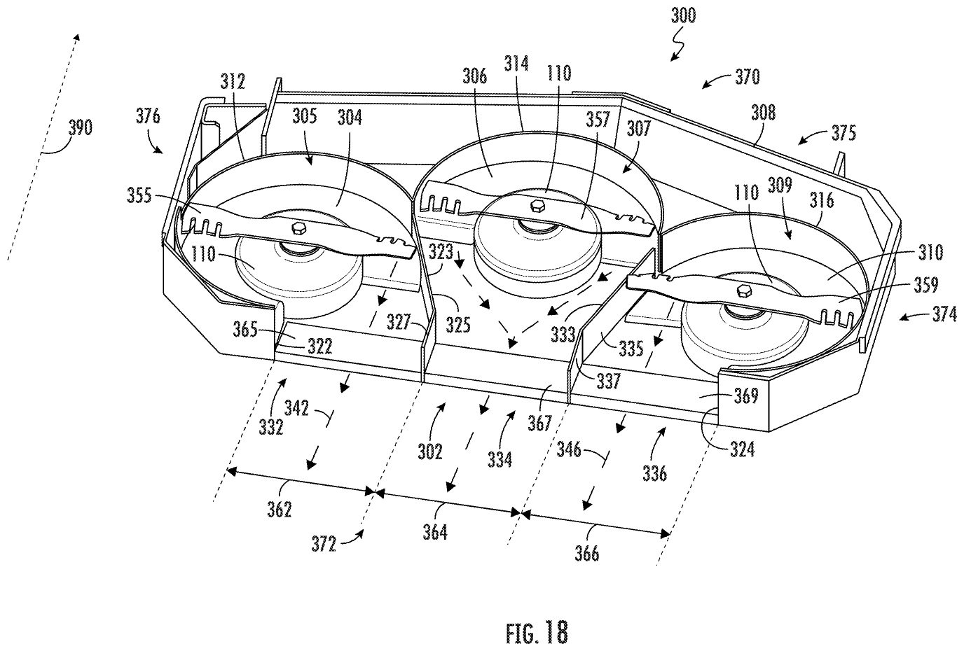

Referring to FIG. 18, a cutting assembly 300 with three motors is shown, according to an exemplary embodiment. The view of the cutting assembly 300 is from the underside 375 of the cutting deck 308. The chore motors 110 are each coupled to and rotate respective blades 355, 357, 359. The right blade 355 is coupled to the chore motor 110 on the right side 376 of the cutting deck 308, the center blade 357 is coupled to the chore motor 110 in the center of the cutting deck, and the left blade 359 is coupled to the chore motor 110 on the left side 374 of the cutting deck 308. The right blade 355 rotates in a clockwise motion when viewing the deck 308 as shown in FIG. 18 (e.g., from the underside 375). The left blade 359 rotates in a counter-clockwise motion when viewing the deck 308 as shown in FIG. 18 (e.g., from the underside 375). The center blade 357 may rotate in either a clockwise or counter-clockwise motion (e.g., as illustrated in FIG. 18, the center blade 357 rotates in a clockwise direction). As such, each of the right blade 355 and the left blade 359 rotates inward toward the center of the deck 308 such that the right blade 355 rotates in an opposite direction relative to the rotation of the left blade 359. Additionally, the cutting assembly 300 and the deck 308 are shown in relationship to a forward direction of travel 390. The forward direction of travel 390 is the direction of travel when the mower to which the deck 308 and the cutting assembly 300 couple to is moving forward (opposite of reverse).

The cutting deck 308 includes a right housing 312 (e.g., a first sidewall in the form of a right sidewall that extends within and from a top of the cutting deck 308 towards the bottom of the cutting deck 308), a center housing 314 (e.g., a third sidewall in the form of a center sidewall that extends within and from a top of the cutting deck 308 towards the bottom of the cutting deck 308), a left housing 316 (e.g., a second sidewall in the form of a left sidewall that extends within and from a top of the cutting deck 308 towards the bottom of the cutting deck 308), and a rear discharge opening 302. The rear discharge opening 302 is defined between a right housing end wall 322 and a left housing end wall 324. The right housing 312, center housing 314, and left housing 316 are generally in a partial circular shape (e.g., the right sidewall, the center sidewall, and the left sidewall that form the right housing 212 and the left housing 214 are partially circular). The right housing 312, center housing 314, and the left housing 316 are shaped and sized to allow the blades 355, 357, 359 to rotate therein (e.g., the right sidewall, the center sidewall, and the left sidewall create a hollow portion therein that is shaped and sized to allow the blades 155, 157 to rotate and fit therein), with a small clearance around the circumference of the housings 312, 314, 316 between the blades 355, 357, 359 and the inner surfaces of the housings 312, 314, 316.

A right baffle 325 forms a part of both the right housing 312 and the center housing 314 (e.g., a part of the right sidewall and the center sidewall). The right baffle 325 extends within the cutting deck 308 from the rear discharge opening 302. The right baffle 325 extends from the top of the cutting deck 308 at least partially into the underside 375 of the cutting deck 308. In some embodiments, the right baffle 325 extends over half way into the underside 375 of the cutting deck 308. A left baffle 335 forms a part of both the left housing 316 and the center housing 314 (e.g., a part of the center sidewall and the left sidewall). The left baffle 335 extends within the cutting deck 308 from the rear discharge opening 302. The left baffle 335 extends from the top of the cutting deck 308 at least partially into the underside 375 of the cutting deck 308. In some embodiments, the left baffle 335 extends over half way into the underside 375 of the cutting deck 308. A right blade cavity 305 is formed by the right housing 312 and the right baffle 325, a center blade cavity 307 is formed by the center housing 314, the right baffle 325, and the left baffle 335, and a left blade cavity 309 is formed by the left housing 316 and the left baffle 335. The right blade 355 rotates within the right blade cavity 305, the center blade 357 rotates within the center blade cavity 307, and the left blade 359 rotates within the left blade cavity 309. The right baffle 325 separates the right blade cavity 305 from the center blade cavity 307 and the left baffle 335 separates the center blade cavity 307 from the left blade cavity 309. Each of the right and left baffles 325, 335 includes a lower wall portion 323, 333 and a higher wall portion 327, 337. The lower wall portions 323, 333 are positioned to allow the blades 355, 357, 359 to pass over the lower wall portion 323, 333.

The rear discharge opening 302 includes a right rear discharge opening 332, a center rear discharge opening 334, and a left rear discharge opening 336. The right rear discharge opening 332 is defined between the right housing end wall 322 and the right baffle 325. The center rear discharge opening 334 is defined between the right baffle 325 and the left baffle 335. The left rear discharge opening 336 is defined between the left housing end wall 324 and the left baffle 335. The right rear discharge opening 332 includes a width 362 of approximately half the width of the right blade 355. The center rear discharge 334 includes a width 364 of approximately half the width of the center blade 357. The left rear discharge opening 336 includes a width 366 of approximately half the width of the left blade 359. Clippings exit the center rear discharge opening 334 in between the drive wheels 104 of the mower 100. Clippings exit the right rear discharge opening 332 both in between the drive wheels and into the right drive wheel 104 and exit the left rear discharge opening 336 both in between the drive wheels and into the left drive wheel 104.

The cutting deck 308 further includes a right deflector plate 365, a center deflector plate 367, and a left deflector plate 369. The right deflector plate 365 is positioned within the right rear discharge opening 332, the center deflector plate 367 is positioned within the center rear discharge opening 334, and the left deflector plate 369 is positioned within the left rear discharge opening 336 (e.g., at the rear discharge opening 302 of the cutting deck 308). As air and clippings exit the cutting deck 308, the air and clippings pass over the right deflector plate 365, the center deflector plate 367, and the left deflector plate 369. The deflector plates 365, 367, 369 deflect clippings down toward the ground (e.g., when the mower 100 is in an operational position shown in FIG. 1). The right deflector plate 365, the center deflector plate 367, and left deflector plate 369 are angled relative to the underside surface of the cutting deck 308 at respective deflector plate angles. In some embodiments, the smaller the angle of the deflector plate, the high efficiency experienced by the cutting assembly 300. The deflector plate angles are equal. In some embodiments, the deflector plate angles are not equal.

A right scroll insert 304 may be positioned within the right blade cavity 305, a center scroll insert 306 may be positioned within the center blade cavity 307, and a left scroll insert 310 may be positioned within the left blade cavity 309. The right scroll insert 304, the center scroll insert 306, and the left scroll insert 310 may be angled (e.g., in the shape of a ramp) and circular in shape such that the scroll inserts 304, 306, 310 surround respective chore motors 110 and the center of blades 355, 357, 359. The scroll inserts 304, 310 ramp downward from proximate respective end walls 322, 324 toward respective baffles 325, 335 in each blade cavity 305, 309 (e.g., ramp downward in a direction toward the direction of blade rotation). The center scroll insert 306 ramps downward in a direction toward the direction of blade rotation (e.g., as shown in FIG. 18, the center blade 357 is configured to rotate in a clockwise direction). The cutting assemblies and decks described herein may also be used in connection with a pod mower deck as described in PCT Publication No. WO2019/035021, filed Aug. 16, 2018, which is incorporated herein by reference in its entirety.

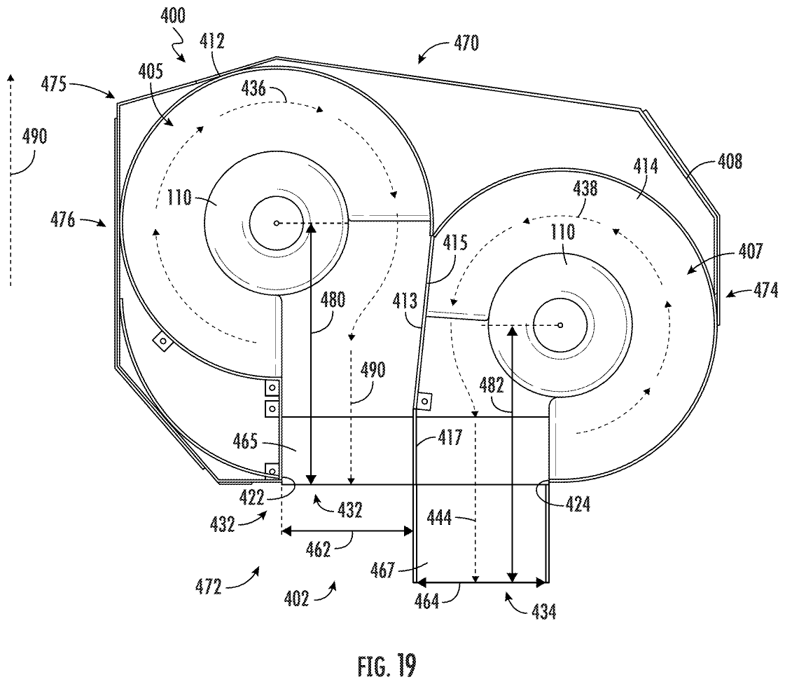

Referring to FIG. 19, a cutting assembly 400 with two motors is shown, according to an exemplary embodiment. The view of the cutting assembly 400 is from the underside 475 such that a front 470, a rear 472, a left side 474, and right side 476 of a cutting deck 408 can be seen. The chore motors 110 are each coupled to and rotate respective blades (not shown). As a result, the first chore motor 110 (the chore motor 110 on the left looking from the underside 475) may be coupled to a first blade in the form of a right blade and the second chore motor 110 (the chore motor 110 on the right looking from the underside 475) may be coupled to a second blade in the form of a left blade. The right blade rotates in a clockwise motion (following clockwise arrow 436) when viewing the deck 408 as shown in FIG. 19 (e.g., from the underside 475). The left blade rotates in a counter-clockwise motion (following counter-clockwise arrow 438) when viewing the deck 408 as shown in FIG. 19 (e.g., from the underside 475). As such, each of the left blade and the right blade rotates inward toward the center of the deck 408 such that the right blade rotates in an opposite direction relative to the rotation of the left blade. Additionally, the cutting assembly 400 and the deck 408 are shown in relationship to a forward direction of travel 490. The forward direction of travel 490 is the direction of travel when the mower to which the deck 408 and the cutting assembly 400 couple to is moving forward (opposite of reverse).

The cutting deck 408 and the cutting assembly 400 are similar to the cutting decks 208, 308 and the cutting assemblies 200, 300 and therefore similar reference numerals are used for components that may be similar or the same. For example, the cutting deck 408 includes a right housing 412 (similar or the same as the right housing 212), a left housing 414 (similar or the same as the left housing 412), and a rear discharge opening 402. It should therefore be understood that any references or statements regarding the cutting decks 208, 308 and the cutting assemblies 200, 300 are applicable to the cutting deck 408 and the cutting assembly 400 even if the cutting deck 408 or the cutting assembly 400 are not shown to include the same component. For example, while the cutting deck 408 is not shown to include a right scroll insert (e.g., similar to the right scroll insert 204) or a left scroll insert (e.g., similar to the left scroll insert 206), the cutting deck 408 may include a right scroll insert and/or a left scroll insert. In this way, the components of the cutting decks 208, 308 and the cutting assemblies 200, 300 are applicable to the cutting deck 408 and the cutting assembly 400, and the components of the cutting assembly 400 and the cutting deck 408 are applicable to the cutting decks 208, 308 and the cutting assemblies 200, 300. As a result, the cutting deck 408 includes a right blade housing 405, a left blade housing 407, a right deflector plate 165, and a left deflector plate 467.

The rear discharge opening 402 includes a first rear discharge opening in the form of a right rear discharge opening 432 and a second rear discharge opening in the form of a left rear discharge opening 434. The right rear discharge opening 432 is defined between the right housing end wall 422 and the baffle 415. The left rear discharge opening 434 is defined between the left housing end wall 424 and the baffle 415. Additionally, the left housing 414 and therefore the left rear discharge opening 434 is shown to extend from the rear 472 of the cutting deck 408 longer than the right housing 412 and therefore the right rear discharge opening 432. In this way, the baffle 415 of the cutting deck 408 may be longer than the baffle 215 of the cutting deck 208 and provides for an extended left rear discharge opening 434. Additionally, the baffle 415 may extend, for a portion, along only the left blade housing 407. Because the chore motors 110 are offset with respect to the forward direction of travel 490 (e.g.., the left chore motor 110 is located behind the right chore motor 110), the clippings and air that are expelled by the left blade housing (e.g., the left blade housing 205) may travel a shorter distance before reaching the discharge opening (when the discharge openings extend the same length from the rear of the deck). This can lead to inefficiency in the housing in which the grass clippings and air travel a shorter distance before reaching the discharge opening. To solve this, the left housing 414 and the right housing 412 each include approximately the same or the same distance that the grass clippings travel to reach the respecting discharge opening. For example, the grass clippings/air of the right housing 412 are shown to travel a distance 480 from the center of the chore motor 110 to the right rear discharge opening 432 and the grass clippings/air of the left housing 414 are shown to travel a distance 482 form the center of the chore motor 110 to the left rear discharge opening 434. In this way, the distance 480 and the distance 482 may be approximately the same. In other embodiments, the right housing 412 may extend from the rear 472 of the cutting deck 408 longer than the left housing 414.

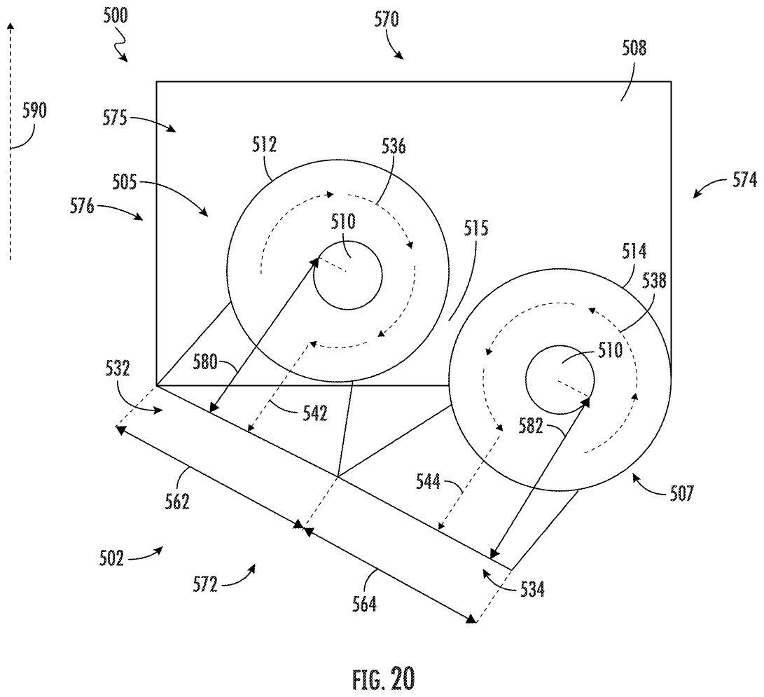

Referring to FIG. 20, a diagram of a cutting assembly 500 with two motors is shown, according to an exemplary embodiment. The view of the cutting assembly 500 is from the underside 575 such that a front 570, a rear 572, a left side 574, and a right side 576 of a cutting deck 508 can be seen. The cutting assembly 500 includes two chore motors 510 (which may be similar or the same as the chore motors 110) that are each coupled to and rotate respective blades (not shown). As a result, the first chore motor 510 (the chore motor 510 on the left looking from the underside 575) may be coupled to a first blade in the form of a right blade and the second chore motor 110 (the chore motor 510 on the right looking from the underside 575) may be coupled to a second blade in the form of a left blade. The right blade rotates in a clockwise motion (follow clockwise arrow 536) when viewing the deck 508 as shown in FIG. 20 (e.g., from the underside 575). The left blade rotates in a counter-clockwise motion (following counter-clockwise arrow 538) when viewing the deck 508 as shown in FIG. 20 (e.g., from the underside 575). As such, each of the left blade and the right blade rotates inward toward the center of the deck 508 such that the right blade rotates in an opposite direction relative to the rotation of the left blade. Additionally, the cutting assembly 500 and the deck 508 are shown in relationship to a forward direction of travel 590. The forward direction of travel 590 is the direction of travel when the mower to which the deck 508 and the cutting assembly 500 couple to is moving forward (opposite of reverse).

The cutting deck 508 and the cutting assembly 500 are similar to the cutting decks 208, 408 and the cutting assemblies 200, 400 and therefore similar reference numerals are used for components that may be similar or the same. For example, the cutting deck 508 includes a right housing 512 (similar or the same as the right housing 212), a left housing 514 (similar or the same as the left housing 212), and a partially rear discharge opening 502. It should therefore be understood that any references or statements regarding the cutting decks 208, 408 and the cutting assemblies 200, 400 are applicable to the cutting deck 508 and the cutting assembly 500 even if the cutting deck 408 or the cutting assembly 400 are not shown to include the same component. For example, while the cutting deck 508 is not shown to include a right scroll insert (e.g., similar to the right scroll insert 204) or a left scroll insert (e.g., similar to the left scroll insert 206), the cutting deck 508 may include a right scroll insert and/or a left scroll insert. In this way, the components of the cutting decks 208, 308 and the cutting assemblies 200, 300 are applicable to the cutting deck 508 and the cutting assembly 500, and the components of the cutting assembly 500 and the cutting deck 508 are applicable to the cutting decks 208, 308 and the cutting assemblies 200, 300.

The partially rear discharge opening 502 includes a first rear discharge opening in the form of a right angled rear discharge opening 532 and a second rear discharge opening in the form of a left angled rear discharge opening 534. The right angled rear discharge opening 532 is defined between the right housing end wall 522 and the baffle 515. The left angled rear discharge opening 534 is defined between the left housing end wall 524 and the baffle 515. As shown, the left housing end wall 524, the right housing end wall 522, and the baffle 515 extend at an angle (e.g., not directly towards the rear 572). In this way, the cutting deck 508 still includes a rear discharge opening, but it is slightly angled (e.g., angled 1, 2, 4, 6, 8, 10, 12, 14, 16, 18, or 20 degrees from the forward direction of travel 590). By doing so, the right housing 512 and the left housing 514 provide the same distance of travel for grass clippings and air from the respective chore motor 510 to the partially rear discharge opening 502. As previously discussed, because the chore motors 510 are offset, typically one housing will have less distance travelled from the chore motor to the discharge opening. In comparison and by having right angled rear discharge opening 532 and the left angled rear discharge opening 534, the right housing 512 has a distance 580 from the center of the chore motor 510 to the right angled discharge opening 532, and the left housing 514 has a distance 582 from the center of the chore motor 510 to the left angled discharge opening 534, with the distance 580 and the distance 582 being the same length. While the left angled discharge opening 534 and the right angled discharge opening 532 are shown as being angled clockwise from the forward direction of travel 590, they may also be angled counter-clockwise from the forward direction of travel 590.

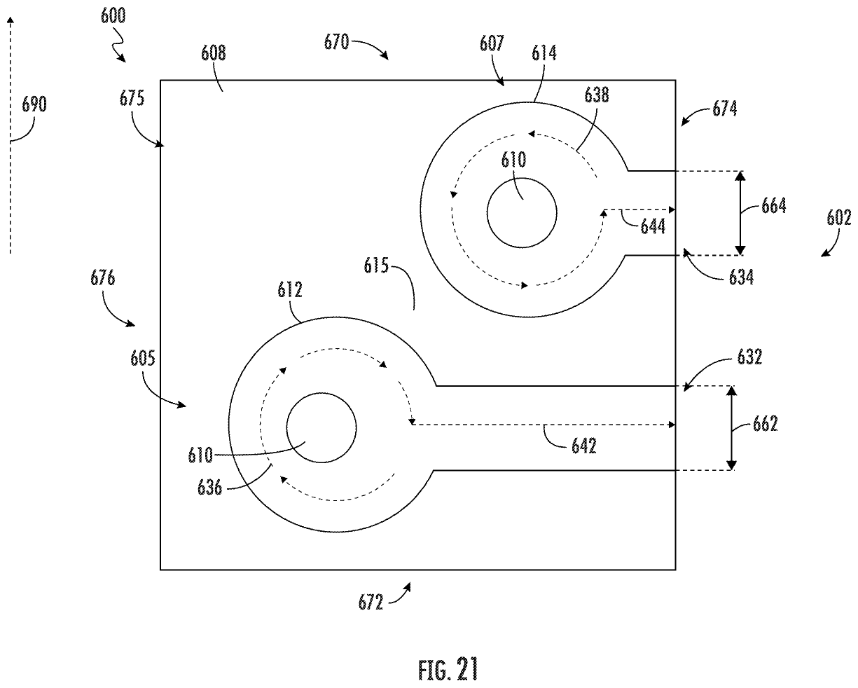

Referring to FIG. 21, a diagram of a cutting assembly 600 with two motors is shown, according to an exemplary embodiment. The view of the cutting assembly 600 is from the underside 675 such that a front 670, a rear 672, a left side 674, and a right side 676 of a cutting deck 608 can be seen. The cutting assembly 600 includes two chore motors 610 (which may be similar or the same as the chore motors 110) that are each coupled to and rotate respective blades (not shown). As a result, the first chore motor 610 (the chore motor 610 toward the rear looking from the underside 675) may be coupled to a first blade in the form of a rear blade and the second chore motor 610 (the chore motor 610 toward the front looking from the underside 675) may be coupled to a second blade in the form of a front blade. The rear blade rotates in a clockwise motion (following clockwise arrow 636) when viewing the deck 608 as shown in FIG. 21 (e.g., from the underside 675). The front blade rotates in a counter-clockwise motion (following counter-clockwise arrow 638) when viewing the deck 608 as shown in FIG. 21 (e.g., from the underside 675). As such, each of the rear blade and the front blade rotates inward toward the center of the deck 608 such that the rear blade rotates in an opposite direction relative to the rotation of the front blade. Additionally, the cutting assembly 600 and the deck 608 are shown in relationship to a forward direction of travel 690. The forward direction of travel 690 is the direction of travel when the mower to which the deck 608 and the cutting assembly 600 couple to is moving forward (opposite of reverse).

The cutting deck 608 and the cutting assembly 600 are similar to the cutting decks 208, 408 and the cutting assemblies 200, 400 and therefore similar reference numerals are used for components that may be similar or the same. For example, while not shown, the cutting deck 608 and the cutting assembly 600 may have a distance from the rear chore motor to a rear side discharge 632 that is equal to the a distance from the front chore motor to a front side discharge 634. In this way, the cutting deck 608 and the cutting assembly 600 may be altered or include one or more components of the cutting decks 208, 308, 408, 508 and the cutting assemblies 200, 300, 400, 500, and vice versa.

The cutting deck 608 includes a first housing in the form of a rear housing 612, a second housing in the form of a front housing 614, and a side discharge opening 602. The side discharge opening 602 is defined between a front housing end wall and a rear housing end wall. The rear housing 612 and front housing 614 are generally in a partial circular shape. The rear housing 612 and the front housing 614 are shaped and sized to allow the blades (e.g., similar to the blade 155, 157) to rotate therein, with a small clearance around the circumference of the housings 612, 614 between the blades the inner surfaces of the housings 612, 614.

A baffle 615 forms a part of both the rear housing 612 and the front housing 614. The baffle 615 extends within the cutting deck 608 from the side discharge opening 602. The baffle 615 extends from the top of the cutting deck 608 at least partially into the underside 675 of the cutting deck 608. In some embodiments, the baffle 615 extends over half way into the underside 675 of the cutting deck 608. A rear blade cavity 605 is formed by the rear housing 612 and the baffle 615 and a front blade cavity 607 is formed by the front housing 614 and the baffle 615. The rear blade rotates within the rear blade cavity 605 and the front blade rotates within the front blade cavity 607. The baffle 615 separates the rear blade cavity 605 from the front blade cavity 607. The baffle 615 may include a lower wall portion and a higher wall portion.

The side discharge opening 602 includes a rear side discharge opening 632 and a front side discharge opening 634. The rear side discharge opening 632 includes a width 662 of approximately half the width of the rear blade. The front side discharge opening 634 includes a width 664 of approximately half the width of the front blade. Clippings exit the rear side discharge opening 632 and the front side discharge opening 634 in between rear drive wheels (e.g., the rear drive wheels 104) and front wheels (e.g., wheel 106). In some embodiments, the rear side discharge opening 632 includes a width 662 greater than half the width of the rear blade and the front side discharge opening 634 includes a width 664 greater than half the width of the front blade. Additionally, while the rear side discharge opening 632 and the front side discharge opening 634 are shown to be located proximate to and discharge clippings, air, and debris to the left side 674 of the cutting deck 608, the rear side discharge opening 632 and the front side discharge opening 634 may be located proximate to and discharge clippings air and debris to the right side 676. In other embodiments, the rear side discharge opening 632 and the front side discharge opening 634 may be located on opposite sides (e.g., one on the left side 674 and one on the right side 676) of the mower deck 608.

The cutting deck 608 may further include a rear deflector plate and a front deflector plate (not shown). The rear deflector plate may be positioned within the rear side discharge opening 632 and the front deflector plate may be positioned within the front side discharge opening 634 (e.g., at the rear discharge opening 202 of the cutting deck 108). The cutting deck 608 may further include a front and rear axial scroll (not shown). The front axial scroll may be located in the front blade cavity and the rear axial scroll may be located in the rear blade cavity. Each scroll cavity may ramp downward from end walls (e.g., from a height of approximately 1.5 inches) toward the baffle 615 in each blade cavity 605, 607 (e.g., ramp downward to a height of zero inches in a direction toward the direction of blade rotation).

As the rear blade rotates, clippings (and air) within the rear blade cavity 605 are directed (e.g., pushed) toward the rear side discharge opening 632 as shown by clockwise arrow 636. As the front blade rotates, clippings (and air) within the front blade cavity 607 are directed (e.g., pushed) toward the front side discharge opening 634 as shown by counter-clockwise arrow 638. The clippings (and air) within rear blade cavity 605 move in a clockwise direction (e.g., arrow 636) and then straight out of the rear side discharge opening 632 (e.g., shown by arrow 642). The clippings (and air) within the front blade cavity 607 move in a counter-clockwise direction (e.g., arrow 638) and then straight out of the front side discharge opening 634. (e.g., shown by arrow 644).

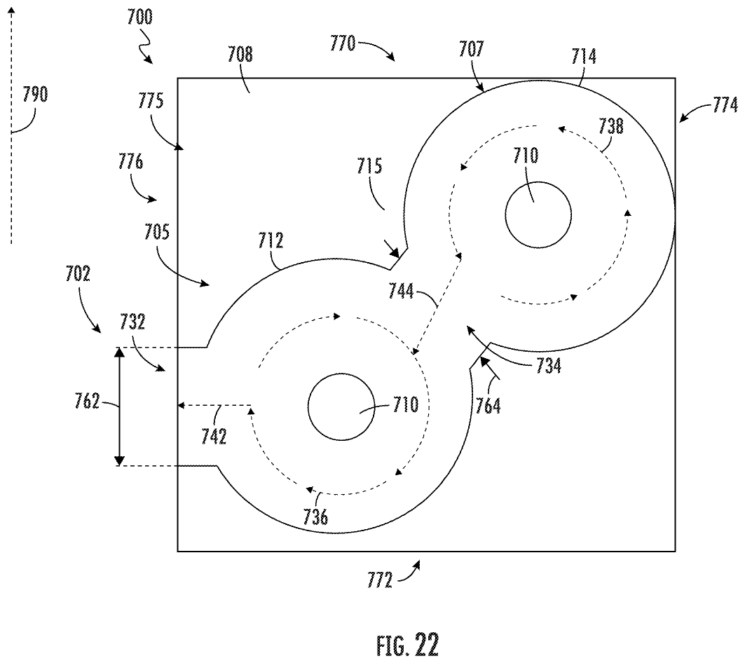

Referring to FIG. 22, a diagram of a cutting assembly 700 with two motors is shown, according to an exemplary embodiment. The view of the cutting assembly 700 is from the underside 775 such that a front 770, a rear 772, a left side 774, and a right side 776 of a cutting deck 708 can be seen. The cutting assembly 700 includes two chore motors 710 (which may be similar or the same as the chore motors 110) that are each coupled to and rotate respective blades (not shown). As a result, the first chore motor 710 (the chore motor 710 toward the rear looking from the underside 775) may be coupled to a first blade in the form of a rear blade and the second chore motor 710 (the chore motor 710 toward the front looking from the underside 775) may be coupled to a second blade in the form of a front blade. The rear blade rotates in a clockwise motion (following clockwise arrow 736) when viewing the deck 708 as shown in FIG. 21 (e.g., from the underside 775). The front blade rotates in a counter-clockwise motion (following counter-clockwise arrow 738) when viewing the deck 708 as shown in FIG. 21 (e.g., from the underside 775). As such, each of the rear blade and the front blade rotates inward toward the center of the deck 708 such that the rear blade rotates in an opposite direction relative to the rotation of the front blade. Additionally, the cutting assembly 700 and the deck 708 are shown in relationship to a forward direction of travel 790. The forward direction of travel 790 is the direction of travel when the mower to which the deck 708 and the cutting assembly 700 couple to is moving forward (opposite of reverse).

The cutting deck 708 and the cutting assembly 700 are similar to the cutting decks 208, 408, 508, 608 and the cutting assemblies 200, 400, 500, 600 and therefore similar reference numerals are used for components that may be similar or the same. For example, while not shown, the cutting deck 708 and the cutting assembly 700 may have a distance from the rear chore motor to a rear side discharge 732 that is equal to the a distance from the front chore motor to a front side discharge 734. In this way, the cutting deck 708 and the cutting assembly 700 may be altered or include one or more components of the cutting decks 208, 308, 408, 508, 608 and the cutting assemblies 200, 300, 400, 500, 600 and vice versa. For example, the cutting deck 708 includes a rear housing 712 (similar or the same as the rear housing 612), a front housing 714 (similar or the same as the front housing 614), and a side discharge opening 702.

The side discharge opening 702 includes a first side discharge opening in the form of a rear side discharge opening 732. The second discharge opening is shown in the form of a center discharge/transfer opening 734. The rear side discharge opening 732 includes a width 762 of approximately half the width of the rear blade. The center discharge opening 734 includes a width 764 of approximately half the width of the front blade. Clippings of the front housing 714 are transferred to the rear housing 712 via the center discharge opening 734 and then the combined set of clippings (e.g., the clippings of the front housing 714 and the rear housing 712) exit the rear side discharge opening 732 in between rear drive wheels (e.g., the rear drive wheels 104) and front wheels (e.g., wheel 106). In this way, the baffle 715 forms of the front housing 714, the rear housing 712, and the center discharge opening 734. Additionally, while the rear side discharge opening 732 is shown to be located proximate to and discharge clippings, air, and debris to the rear right side 776 of the cutting deck 708, the rear side discharge opening 732 may be located proximate to and discharge clippings air and debris to the front, left side 774.

As the front blade rotates, clippings (and air) within the front blade cavity 707 are directed (e.g., pushed) toward the center discharge opening 734 as shown by counter-clockwise arrow 738. The clippings (and air) within the front blade cavity 707 then move into the rear blade cavity 705 (e.g., via the center discharge opening 734). As the rear blade rotates, the combined set of clippings (and air) within the rear blade cavity 705 are directed (e.g., pushed) toward the rear side discharge opening 732 as shown by clockwise arrow 736. The combined clippings (and air) within the rear blade cavity 705 then are discharged through the side discharge opening 702 (e.g., via the rear discharge opening 732) and exit the cutting deck 708.

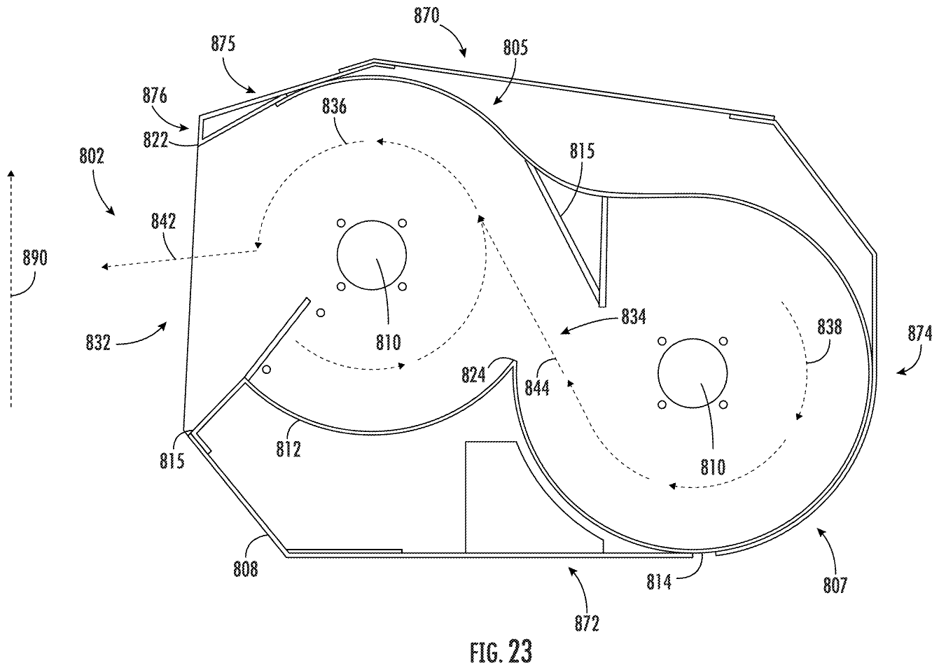

Referring to FIG. 23, a diagram of a cutting assembly 800 with two motors is shown, according to an exemplary embodiment. The view of the cutting assembly 800 is from the underside 875 such that a front 870, a rear 872, a left side 874, and a right side 876 of a cutting deck 808 can be seen. The cutting assembly 800 includes two chore motors 810 (which may be similar or the same as the chore motors 110) that are each coupled to and rotate respective blades (not shown). As a result, the first chore motor 810 (the chore motor 810 toward the right side 876 looking from the underside 875) may be coupled to a first blade in the form of a right blade and the second chore motor 710 (the chore motor 810 toward the left side 874 looking from the underside 875) may be coupled to a second blade in the form of a left blade. The right blade rotates in a counter-clockwise motion (following counter-clockwise arrow 836) when viewing the deck 808 as shown in FIG. 23 (e.g., from the underside 875). The left blade rotates in a clockwise motion (following clockwise arrow 838) when viewing the deck 808 as shown in FIG. 23 (e.g., from the underside 875). As such, each of the right blade and the left blade rotates inward toward the center of the deck 808 such that the right blade rotates in an opposite direction relative to the rotation of the left blade. Additionally, the cutting assembly 800 and the deck 808 are shown in relationship to a forward direction of travel 890. The forward direction of travel 890 is the direction of travel when the mower to which the deck 808 and the cutting assembly 800 are coupled to is moving forward (opposite of reverse).

The cutting deck 808 and the cutting assembly 800 are similar to the cutting decks 208, 408, 508, 608, 708 and the cutting assemblies 200, 400, 500, 600, 700 and therefore similar reference numerals are used for components that may be similar or the same. For example, while not shown, the right side discharge opening 832 may include a width that is approximately half the width of the left blade, and the center discharge opening 834 may include a width that is approximately half the width of the right blade. In this way, the cutting deck 808 and the cutting assembly 800 may be altered or include one or more components of the cutting decks 208, 308, 408, 508, 608, 708 and the cutting assemblies 200, 300, 400, 500, 600, 700 and vice versa. For example, the cutting deck 808 includes a right housing 812 (similar or the same as the front housing 614 and the right housing 212), a left housing 814 (similar or the same as the rear housing 612 and the left housing 214), and a side discharge opening 802.

The side discharge opening 802 includes a first side discharge opening in the form of a right side discharge opening 832. The second discharge opening is shown in the form of a center discharge/transfer opening 834. Clippings of the left housing 814 are transferred to the right housing 812 via the center discharge opening 834 and then the combined set of clippings (e.g., the clippings of the right housing 812 and the left housing 814) exit the right side discharge opening 832 in between rear drive wheels (e.g., the rear drive wheels 104) and front wheels (e.g., wheel 106). In this way, the baffle 815 forms a part of the right housing 812, the left housing 814, and the center discharge opening 834. Additionally, while the right side discharge opening 832 is shown to be located proximate to and discharge clippings, air, and debris to the right side 876 of the cutting deck 808, the right side discharge opening 832 may be located proximate to and discharge clippings air and debris to the left side 874.

As the left blade rotates, clippings (and air) within the left blade cavity 807 are directed (e.g., pushed) toward the center discharge opening 834 as shown by counter-clockwise arrow 838. The clippings (and air) within the left blade cavity 807 then move into the right blade cavity 805 (e.g., via the center discharge opening 834). As the left blade rotates, the combined set of clippings (and air) within the right blade cavity 805 are directed (e.g., pushed) toward the right side discharge opening 832 as shown by clockwise arrow 836. The combined clippings (and air) within the right blade cavity 805 then are discharged through the side discharge opening 802 (e.g., via the right side discharge opening 832) and exit the cutting deck 808.

The cutting assemblies 200, 300, 400, 500, 600, 700, and 800 described herein may increase the overall efficiency of the mower 100. As compared with a standard side discharge cutting deck, the cutting decks 108, 308, 408, 508, 608, 708, and 808 described herein may improve the air flow efficiency by approximately 75%, and as compared with a standard rear (or side) discharge deck (e.g., belt-drive, blades rotating in the same direction), the cutting decks 108, 308, 408, 508, 608, 708, and 808 described herein may improve the air flow efficiency by approximately 50%. In addition, the cutting assemblies 200, 300, 400, 500, 600, 700, and 800 described herein reduce the overall noise emitted from the mower 100. For example, the mower 100 described herein is approximately 10 decibels (dB) quieter than a standard gas-powered, side-discharge mower. The noise at the operator's ears emitted from the mower 100 described herein may be approximately 81 dB, which is lower than the noise level (85 dB) at which ear protection is required. In addition, due to the reduced noise levels emitted from the mower 100, the typical working day can be extended, where an operator can now mow early in the morning and late at night without creating a disturbance.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. For example, the side discharge blade cavities of the exemplary embodiment described in at least paragraph(s) [0077-0084] may be incorporated in the three blade cavities of the exemplary embodiment described in at least paragraph(s) [0067-0071]. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. Outdoor power equipment comprising:
a frame;
a battery;
a plurality of wheels coupled to the frame;
a cutting deck coupled to the frame and having a discharge opening;
a plurality of electric chore motors attached to the cutting deck and selectively powered by the battery; and
a plurality of blades, each blade powered and rotated by one of the plurality of electric chore motors,
wherein a first blade of the plurality of blades is rotated in a first direction and a second blade of the plurality of blades is rotated in a second direction opposite the first direction.

2. The outdoor power equipment of claim 1, wherein the discharge opening is a rear discharge opening, wherein the cutting deck includes a top, a bottom, a right side, and a left side with respect to a forward direction of travel of the outdoor power equipment such that the top side is located closer to the frame than the bottom side, wherein the first blade of the plurality of blades is positioned on the right side of the cutting deck and the second blade of the plurality of blades is positioned on the left side of the cutting deck, and wherein the first blade of the plurality of blades is rotated in a counter-clockwise direction when viewed from the top of the cutting deck and the second blade of the plurality of blades is rotated in a clockwise direction when viewed from the top of the cutting deck.

3. The outdoor power equipment of claim 1, wherein a third blade of the plurality of blades is rotated in at least one of the first direction and the second direction, and wherein the cutting deck comprises:
a first blade cavity housing the first blade of the plurality of blades;
a second blade cavity housing the second blade of the plurality of blades;
a third blade cavity housing the third blade of the plurality of blades;
a first baffle separating the first blade cavity from the third blade cavity; and
a second baffle separating the second blade cavity from the third blade cavity.

4. The outdoor power equipment of claim 1, wherein the cutting deck comprises:
a first sidewall located within the cutting deck;
a second sidewall located within the cutting deck;
a baffle forming a part of the first sidewall and the second sidewall;
a first blade cavity housing the first blade of the plurality of blades and formed by the first sidewall and the baffle; and
a second blade cavity housing the second blade of the plurality of blades and formed by the second sidewall and the baffle.

5. The outdoor power equipment of claim 1, further comprising a motor controller structured to control the operation of the plurality of electric chore motors and positioned above the battery.

6. The outdoor power equipment of claim 1, further comprising a motor controller structured to control the operation of the plurality of electric chore motors and positioned on the cutting deck.

7. The outdoor power equipment of claim 1, further comprising an operator platform and a plurality of drive motors selectively powered by the battery, wherein a first drive motor of the plurality of drive motors is coupled to a first wheel of the plurality of wheels and a second drive motor of the plurality of drive motors is coupled to a second wheel of the plurality of wheels, and wherein the operator platform is positioned underneath the first drive motor and the second drive motor in a normal operating position of the equipment.

8. A cutting deck for use with an electric stand-on mower comprising:
a discharge opening;
a plurality of electric chore motors attached to the cutting deck; and
a plurality of blades, each blade powered and rotated by one of the plurality of electric chore motors,
wherein a first blade of the plurality of blades is rotated in a first direction and a second blade of the plurality of blades is rotated in a second direction opposite the first direction.

9. The cutting deck of claim 8, wherein the discharge opening is a rear discharge opening, wherein the cutting deck includes a top, a bottom, a right side, and a left side with respect to a forward direction of operation of the cutting deck, wherein the first blade of the plurality of blades is positioned on the right side of the cutting deck and the second blade of the plurality of blades is positioned on the left side of the cutting deck, and wherein the first blade of the plurality of blades is rotated in a counter-clockwise direction when viewed from the top of the cutting deck and the second blade of the plurality of blades is rotated in a clockwise direction when viewed from the top of the cutting deck.

10. The cutting deck of claim 8 wherein the discharge opening is a side discharge opening, wherein the cutting deck includes a top, a bottom, a front, and a rear with respect to a forward direction of operation of the cutting deck, wherein the first blade of the plurality of blades is positioned on the front of the cutting deck and the second blade of the plurality of blades is positioned on the rear of the cutting deck, and wherein the first blade of the plurality of blades is rotated in a counter-clockwise direction when viewed from the top of the cutting deck and the second blade of the plurality of blades is rotated in a clockwise direction when viewed from the top of the cutting deck.

11. The cutting deck of claim 8, wherein the cutting deck comprises:
a first sidewall located within the cutting deck;
a second sidewall located within the cutting deck;
a baffle forming a part of the first sidewall and the second sidewall;
a first blade cavity housing the first blade of the plurality of blades and at least partially housing a first electric chore motor of the plurality of electric chore motors, the first blade cavity formed by the first sidewall and the baffle; and
a second blade cavity housing the second blade of the plurality of blades and at least partially housing a second electric chore motor of the plurality of electric chore motors, the second blade cavity formed by the second sidewall and the baffle.

12. The cutting deck of claim 11, further comprising a first rear discharge opening and a second rear discharge opening separated by the baffle, wherein clippings from the first blade cavity are discharged through the first rear discharge opening and clippings from the second blade cavity are separately discharged through the second rear discharge opening.

13. The cutting deck of claim 12, further comprising a first axial scroll positioned around the first electric chore motor of the plurality of electric chore motors and a second axial scroll positioned around the second electric chore motor of the plurality of electric chore motors, the first axial scroll comprising a first ramp structure tapering downward in the first direction and the second axial scroll comprising a second ramp structure tapering downward in the second direction.

14. The cutting deck of claim 12, wherein a first distance from a center of the first electric chore motor of the plurality of electric chore motors to the first rear discharge opening is approximately equal in length to a second distance from a center of the second electric chore motor of the plurality of electric chore motors to the second rear discharge opening.

15. The cutting deck of claim 12, further comprising a first deflector plate positioned within the first rear discharge opening and a second deflector plate positioned within the second rear discharge opening, the first deflector plate comprising a first deflector plate opening through which clippings from the first blade cavity are discharged and the second deflector plate comprising a second deflector plate opening through which clippings from the second blade cavity are discharged.

16. A lawnmower comprising:
a frame;
a battery
a plurality of wheels coupled to the frame;
a first electric chore motor coupled to a first blade and powered by the battery;
a second electric chore motor coupled to a second blade and powered by the battery; and
a cutting deck coupled to the frame and housing the first blade and the second blade and comprising a first blade cavity and a second blade cavity, the first blade cavity and the second blade cavity separated by a baffle,
wherein the first blade rotates in a first direction and the second blade rotates in a second direction opposite the first direction.

17. The lawnmower of claim 16, wherein the first direction is clockwise and the second direction is counter-clockwise and wherein clippings from the first blade and the second blade are discharged through a rear discharge opening in between a first wheel of the plurality of wheels and a second wheel of the plurality of wheels.

18. The lawnmower of claim 16, wherein the first direction is clockwise and the second direction is counter-clockwise and wherein clippings from the first blade and the second blade are discharge through a side discharge opening in between a first wheel of the plurality of wheels and a second wheel of the plurality of wheels.

19. The lawnmower of claim 16, further comprising an operator platform, wherein a first wheel of the plurality of wheels and a second wheel of the plurality of wheels have an outer diameter at least partially defining a rearmost surface of the first wheel and the second wheel of the plurality of wheels, the rearmost surface positioned rearward on the equipment than an entirety of the operator platform in a normal operating position of the equipment.

20. The lawnmower of claim 16, further comprising a third electric chore motor coupled to a third blade, wherein the cutting deck further houses the second blade, and wherein the third blade rotates in at least one of the first direction and the second direction.
